(19) United States
(12) Patent Application Publication
(10) Pub. No.: US 2011/0246231 A1
(43) Pub. Date: Oct. 6, 2011

(54) ACCESSING PATIENT INFORMATION

(75) Inventors: Yu Lin Sie, Bellevue, WA (US); VenkataChari SampathKumar, Sammamish, WA (US); Jason R. W. Ramsay, Seattle, WA (US); Jeffrey Winter, Seattle, WA (US); Margaret Elisabeth Rottsolk, Seattle, WA (US); Shawna D. Cooper, Redmond, WA (US); Keith Daniels, Seattle, WA (US); Katherine W. Osborne, Kirkland, WA (US); Pranavakumar Punniamoorthy, Redmond, WA (US); Matthew Bordenet, Sammamish, WA (US); Suzanne Tocco, Bellevue, WA (US); Muzammil Ahmed, Seattle, WA (US)

(73) Assignee: Microsoft Corporation, Redmond, WA (US)

(21) Appl. No.: 12/751,984

(22) Filed: Mar. 31, 2010

(51) Int. Cl. G06Q 50/00; G06Q 10/00; G06F 17/30; G06F 3/048

(52) U.S. Cl. 705/3; 707/802; 715/809; 715/764; 707/E17.044

(57) ABSTRACT

A connection component generates a user interface for display to a patient computing device. The user interface provides the patient computing device with access to hospital visit records of the patient maintained in a hospital database. The user interface may further receive selection of a care provider by the patient for granting the care provider electronic access to the patient's hospital visit records.

### BACKGROUND

Hospitals typically use enterprise database systems to maintain records of each patient's visit to the hospital. When a patient is released from the hospital, the hospital may provide information to the patient regarding the patient's visit and any follow-up care, medications prescribed, lab reports, information and instructions for the patient's personal doctor, or the like. Traditionally, if this information is made available to the patient, it is printed onto paper and provided to the patient when the patient is discharged. Oftentimes, the information provided at discharge is incomplete and may merely include a portion of the information desired by the patient or the patient's personal care providers.

As part of an effort to improve availability of patient information, a standard for creating and maintaining an electronic record of a patient's health summary has been established by the American Society of Testing and Materials (ASTM) as the ASTM E2369-05e1 standard. The ASTM E2369-05e1 standard specifies a continuity of care record (CCR), which provides the ability for one healthcare practitioner, system, or setting to aggregate pertinent data about a patient and forward this information to another practitioner, system, or setting to support continuity of care. Thus, the CCR is able to essentially provide a snapshot in time of pertinent clinical, demographic, and administrative data for a specific patient. However, because the CCR usually contains personal patient data, end-to-end CCR document integrity and confidentiality is desired for conforming to regulations or other security, confidentiality, or privacy protections. Conditions of security and privacy for a CCR instance make it desirable to allow only properly authenticated and authorized access to a CCR document instance or its elements. Consequently, as with other hospital records, a CCR, if provided to the patient at all, is typically printed out in whole or in part, and given to a patient on paper during discharge. This practice can limit the access of the patient and the patient's other care providers to desirable or vital patient information.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide a user with electronic access to patient information maintained in a secure database. In some implementations users may specify care providers to be permitted to electronically access the patient information maintained in the secure database. Further, in some implementations, a user can determine a status or condition of available patient information.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 depicts a block diagram of an example framework for accessing patient information according to some implementations disclosed herein.

FIG. 2 depicts a flow diagram of an example process for employing a connection component to access patient information according to some implementations.

FIGS. 3A-3B depict block diagrams of examples of systems for accessing patient information according to some implementations disclosed herein.

FIG. 4 depicts an example of a portal overview page according to some implementations.

FIG. 5 depicts an example of a hospital visit record list page according to some implementations.

FIGS. 6A-6B depict an example of a hospital visit record according to some implementations.

FIGS. 7A-7E depict examples of portal pages and application windows for managing care provider access to patient records according to some implementations.

FIG. 8 depicts an example of an accounts settings page according to some implementations.

FIGS. 9A-9B depict an example of block diagram illustrating account relationships according to some implementations.

FIG. 10 depicts an example system architecture according to some implementations.

FIG. 11 depicts an example of a hospital computing device according to some implementations.

FIG. 12 depicts an example of a health repository computing device according to some implementations.

FIG. 13 depicts an example of a client computing device according to some implementations.

### DETAILED DESCRIPTION

### Communicating Patient Information

The technologies described herein are generally directed towards providing access to patient information maintained in a secure database. Some implementations provide a portal through which the patient is able to access the patient's information maintained by a hospital, clinic, outpatient facility, physician's office, or the like (hereafter “hospital”). Consequently, a patient is able to actively manage his or her hospital visit records, preregistrations, and connections to care providers (e.g., primary care physician, referring physician, nursing home staff, etc.) and other patient information outside of the hospital infrastructure. For example, in some implementations, the patient is able to electronically access patient information (e.g., patient hospital visit records, such as continuity of care records (CCRs), continuity of care documents (CCDs), or other patient information) pertaining to one or more visits by the patient to the hospital. Thus, implementations herein provide for a secure portal by which patients are able to access their information maintained by a hospital database.

Further, in some implementations the patient is able to specify one or more care providers, such as personal doctors, nurses, nursing homes, etc., who are permitted to electronically access the patient's information maintained by the hospital. For example, the patient is able to specify particular care providers the hospital may permit to access the patient's hospital visit information maintained by the hospital and secured by the portal. Thus, implementations herein provide a mechanism for patients to connect their records to professional care providers, subject to hospital approval. Following hospital approval, the care providers can access the patient's hospital visit records to support patient continuity of care and ease the burden on hospital medical records staff of sending individual health records outside of the hospital infrastructure to care providers.

Furthermore, according to some implementations, the hospital visit records can be dynamically generated, such as when requested by a patient or care provider to enable viewing of available records at any time. For example, a patient may access his or her visit record through the patient portal even before being discharged from the hospital, and is able to see any reports already available while still in the hospital. Additionally, when viewing a list of available visit records, any updates that have been made to a particular hospital visit record may be indicated to the patient when the patient views the list of visit records. In addition, implementations herein support the ability for a user to view and manage hospital visit records for one or more patients, such as for the user's entire family, or anyone for whom the user manages a record, through one account and login, thereby easing the burden of healthcare record management.

In some implementations, a patient may have a health repository account in an online health repository that is external with respect to the hospital infrastructure and the hospital database. By creating an account with the connection component and carrying out a matching and linking process, the patient is able to link patient records in the hospital database to the health repository account through the account created using the connection component. This linking of records and accounts enables a flow of information between the patient information contained in the hospital database and the health repository account. Thus, some implementations herein provide patients access to patient information contained in a hospital database through a secure connection component for enabling the patients to access their patient information maintained by a hospital. In addition, the patient may also provide preregistration information obtained from the health repository account to the hospital through the connection component.

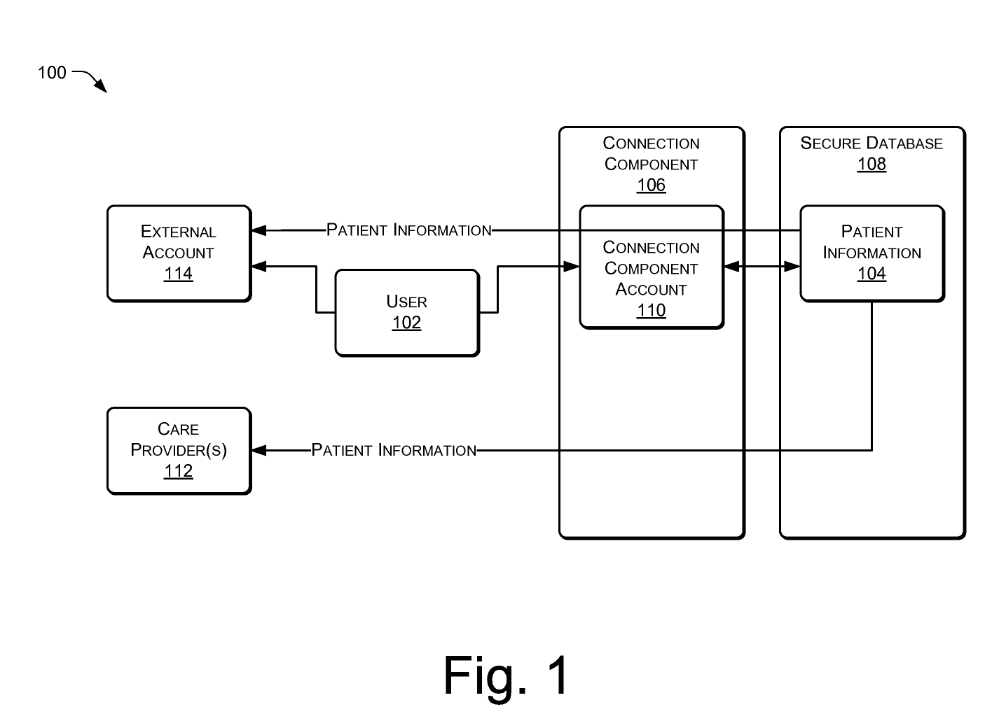

FIG. 1 illustrates an example for discussion purposes of a framework 100 to provide a user 102 with electronic access to patient information 104, such as patient care information, e.g., hospital visit records, preregistration information, or the like. For example, the user may be the patient, or the user may be acting on behalf of the patient, such as in the case of a parent acting for a child, or other person authorized to act on behalf of the patient. In the illustrated example, framework 100 includes a connection component 106, which may be an application or other component able to electronically communicate with both the user 102 and a secure database 108. For instance, secure database 108 may be a database securely storing patient information, such as hospital visit records, or the like, as described herein. Connection component 106 is configured to interact with the secure database 108 for providing the user 102 with access to the patient information 104. For example, as described additionally below, the user 102 may create a connection component account 110 that is used to securely match an identity of a patient with an identity corresponding to the patient information 104 maintained in the database 108 to enable the user 102 to electronically access and receive the patient information 104.

Responsive to the matching of patient identification information provided by the user to the identity corresponding to the patient information 104 in the secure database 108, an external account 112 of the user and the connection component account 110 of the user may be linked with the patient information 104 contained in the secure database 108. For example, external account 112 may be an account that is external to the secure database 108 and controlled by the user, such as a personal account in an online service or database, which may be provided through a web interface, website or the like. In some implementations, the user's connection component account 110 may use the same login identifier and password as the external account 112 of the user, and both accounts 110, 112 may be created during a single sign up procedure, or during separate sign ups. Accordingly, the patient information 104 may be received by the external account 112. Further, during pre-registration, the user may obtain information from the external account 112 for use during pre-registration. Following matching and linking, the user is able to view the patient information 104 through the connection component account 110, such as for determining a status or condition of the patient information 104.

Furthermore, following the matching and linking, connection component 106 can enable the user 102 to identify or specify one or more care providers 114 that the user would also like to have permitted to access the patient information 104. Subject to approval by the hospital, the patient information 104 can then be provided to the specified care provider 114. Also, in other implementations, the care providers 114 may independently request access to the patient information 104, or the hospital staff may provide the access in response to other instructions received independently of the connection component 106. Consequently, implementations herein provide a framework by which patients and their care providers are able to securely electronically access patient information 104 in a secure database 108.

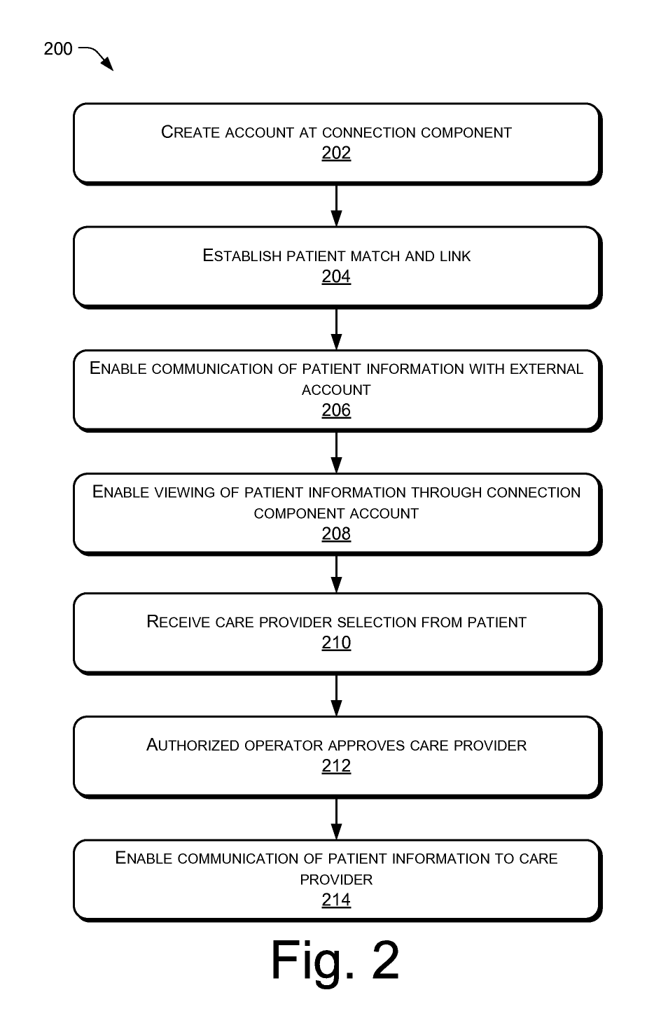

FIG. 2 illustrates an example of a process 200 for electronically accessing patient visit information according to some implementations herein. In the flow diagram, the operations are summarized in individual blocks. The operations may be performed in hardware, or as processor-executable instructions (software or firmware) that may be executed by one or more processors. Further, the process 200 may, but need not necessarily, be implemented using the framework of FIG. 1. Consequently, by way of explanation, and not limitation, the process 200 is described in the context of the framework of FIG. 1.

At block 202, in response to actions by a user, the connection component creates an account for the user. For example, the user may access the connection component over the Internet (e.g., the World Wide Web) for creating an account. Furthermore, in some implementations, the connection component account created on the connection component may map at least in part to an external account of the user, such as in an online database, web service, website, or the like, as is described additionally below. In some implementations, the user may sign up for the external account during the process of signing up for the account on the connection component, such as by being redirected from the connection component to the online database website, and then being redirected back to the connection component following creation of the external account.

At block 204, a patient match and link is established based on information received from the user. For example, the user may provide specified identification information for a patient to enable the connection component to securely match the identification information for the patient with patient identity information contained in the secure database. The matching may be an automated process carried out by the connection component, or may involve manual oversight by hospital staff or other authorized operator.

At block 206, following approval of the patient matching and linking, an external account of the user and the connection component account of the user may be securely linked to the patient information contained in the secure database. The linking of the external account to the patient information in the secure database enables the corresponding patient information to be moved between the database and the external account. In addition, the user may also access or view the patient information in the secure database through the connection component account.

At block 208, following matching and linking of the connection component account to the patient information in the database, a user interface may provide a number of options for accessing and viewing the patient information in the secure database, such as for viewing a status of the patient information, determining whether the patient information has been delivered to the external account, and the like.

At block 210, following successful matching and linking of the patient information, the portal interface may further enable the user to specify one or more care providers that the user would also like to be able to access the patient information contained in the secure database. For example, the user can provide identification information for a personal care provider that the user would like to have receive the patient information.

At block 212, an authorized operator, such as a hospital staff member, reviews the patient request to allow the specified care provider to access the patient information. The request may be granted if the care provider is properly identified and meets other criteria set by the hospital, such as being registered with the hospital, or the like. Further, in other implementations, described below, the care provider may initiate the request for access, or the hospital staff may provide the access in response to instructions received by other means than the connection component 106.

At block 214, following approval of the specified care provider, the patient information is provided to the care provider. Consequently, the above framework 100 and process 200 can be used for providing a patient and/or the patient's care providers with electronic access to the patient's information in a secure database.

### Accessing Patient Visit Information

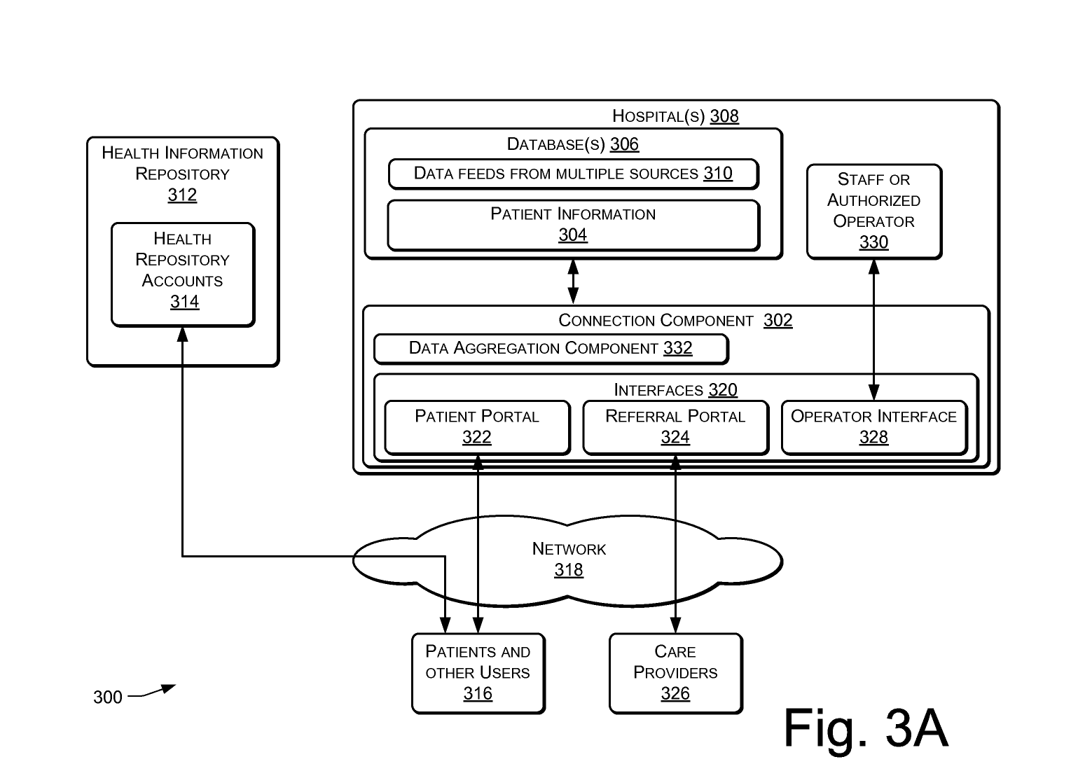

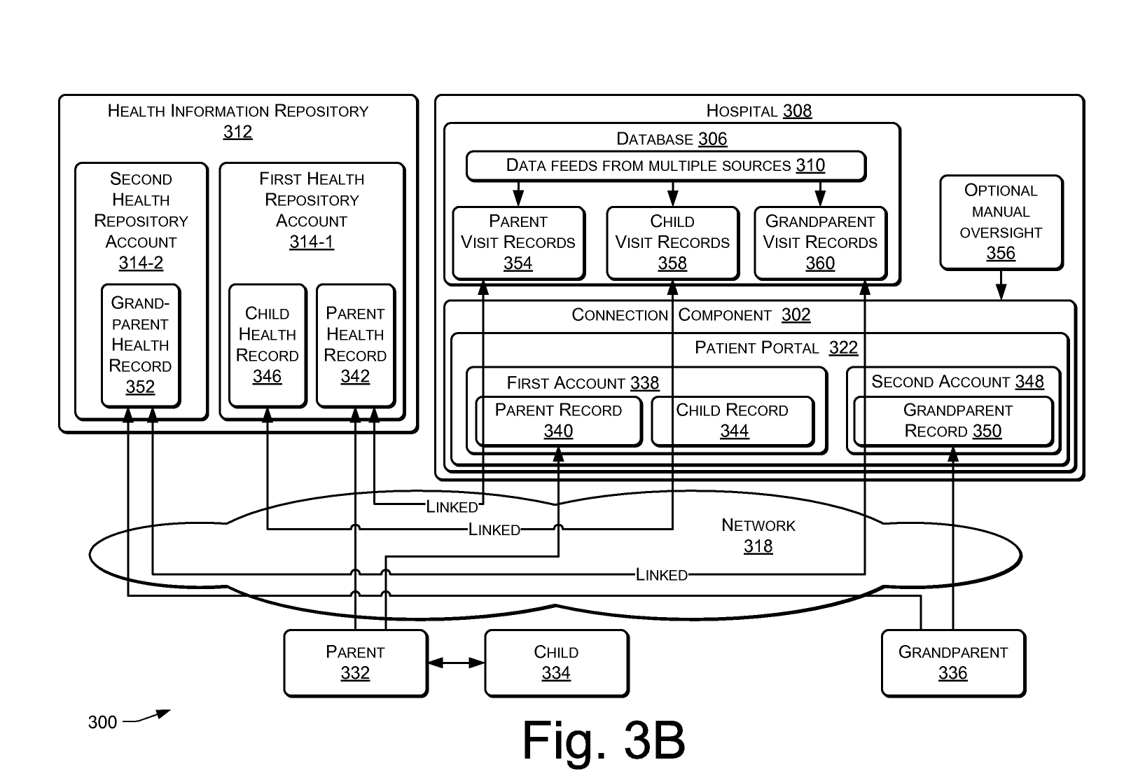

FIG. 3A illustrates an example of a system 300 for accessing patient information, such as hospital visit information, or the like, according to some implementations herein. The system 300 includes a connection component 302 for enabling electronic access to patient information 304 in one or more hospital data stores or databases 306 of one or more hospitals 308. According to some implementations, the hospital data store or database 306 (hereafter “database 306”) may be a unified data aggregation platform able to receive data feeds 310 from multiple sources such as a plurality separate applications and databases in the hospital, such as in different departments, etc. An example of such a healthcare data aggregation platform is Microsoft® Amalga™ Unified Intelligence System available from Microsoft Corporation of Redmond, Wash. Thus, the hospital database 306 may be a suitable platform or database able to tap into and receive existing data feeds from other applications, databases and departments throughout the hospital for gathering and merging the available information on the particular patient to create a unified record of the patient's visit. For example, the patient information 304 may be hospital visit information that may include information or reports obtained from patient registration, operation or surgery information, radiology information, prescription and pharmaceutical information, therapeutic treatment information, doctor and nursing notes, and the like, gathered from a variety of different sources and storage locations throughout the hospital. Consequently, in some implementations, data feeds 310 from multiple sources can be automatically gathered or received by database 306 and added to patient information 304.

Additionally, in other implementations, the hospital database 306 may be a different type of database that contains patient hospital visit information that is manually assembled or generated using other types of technology. For example, in these implementations, patient hospital visit records may be manually generated and entered into hospital database 306. Further, the hospital database 306 may be located at the hospital 308, or may be located at a remote location relative to the hospital 308. For example, the database 306 may be hosted at a data center accessible over the Internet or though other suitable communication link. Consequently, implementations herein are not limited to a particular hospital database type.

System 300 also may include a health information repository 312 that is external to the hospital database 306 and any hospital infrastructure. According to some implementations, the health information repository 312 may be a website, web server, or the like. The health information repository 312 may provide an online database or platform that allows individuals to store and personally manage in a central location personal health and fitness information obtained from a number of different sources. An example of a suitable platform is Microsoft® HealthVault™ available from Microsoft Corporation of Redmond, Wash., although other suitable online databases and repositories may also be used. In some implementations, health information repository 312 may allow access to an individual's health record through a health repository account 314. Thus, health repository account 314 may be used to store health and fitness information that is accessible by patients and other users 316 over a network 318, such as the Internet or other suitable communication network. Other users might include individuals authorized to act for the patient, or the like. Further, a single health repository account 314 may be used to manage and access health records for a plurality of individuals, such as the members of a family, e.g., parent health records and the health records of the parents' children. As one possible example, an individual may be able to access his or her own health record and also the health record of a child, spouse, parent or the like contained in the same account.

Additionally, it is also possible for a first health repository account to grant a second health repository account full or partial access to one or more health records in the first account. For instance a user might have complete read and write access to all the health records in their health repository account, such as the health records of their spouse or child. Also, another individual, such as a grandparent having a second account, might be granted read and write or read-only access to one or more of the health records in the first account through a second account, or the like. Thus, the health records in the health information repository 312 may be configured to be accessed in whole or in part by one or more authorized or registered individuals.

Connection component 302 may include interfaces 320 for enabling access and interaction with the connection component 302. For example, connection component 302 may include a patient portal 322 that can be used by patients and other users 316 to access connection component 302, such as for creating an account to view patient information 304 and for linking patient information 304 to a health repository account 314. In some implementations, patient portal 322 may be a website, web service, or the like, accessible over network 318, such as through the World Wide Web.

Connection component 302 may further include a referral portal 324 that can be used by care providers for accessing patient information 304. For example, care providers 326, such as personal physicians, referring physicians, clinics outside the hospital, nursing homes, and other types of care providers external to the hospital can be authorized through the referral portal 324 to access patient information 304 for a particular patient. This authorization may be the result of a request made by a patient or other user 316, or a request made by a care provider 326, and is subject to review and approval by the hospital staff In some implementations, referral portal 324 may be a website, web service, or the like, accessible over network 318, such as through the World Wide Web. In some implementations, care providers 326 can use the referral portal to create connection component accounts for accessing patient information. For example, when a care provider wishes to access visit records for a particular patient, the care provider may provide identification information about the particular patient similar to the patient matching that may be carried out by a patient for accessing information of an identified patient.

Connection component 302 may further include an operator interface 328 for use by authorized operators 330 of the connection component, such as hospital staff, system administrators, or the like. For example, hospital staff may oversee or control a number of operations of the connection component as described additionally below, such as overseeing patient matching and linking, reviewing requests from patients or care providers to provide access by care providers to patient information, and the like.

Connection component 302 may further include a data aggregation component 332 that aggregates and monitors patient information 304. For example, data aggregation component may determine whether patient information 304 for a particular patient has been updated, and provide the patient with an indication of the update when the patient accesses the patient portal. Further, aggregation component 332 may perform numerous other functions, such as creating metadata for monitoring patient information 304, monitoring patient access to the patient information, and the like.

FIG. 3B sets forth an additional example for explanation purposes of the system 300 described above. In this example, a parent 332 has a child 334 and a parent, i.e., grandparent 336. The parent, child and grandparent are examples of possible patients and/or users of the system, but implementations herein are not limited by this example.

In the system 300 of FIG. 3B, a parent 332 is able to access patient portal 322 of connection component 302 through network 318. According to some implementations, when parent 332 first connects with the connection component 302, parent 332 may use the patient portal 322 to create a first account 338. In some implementations, the first account 338 may map to a first health repository account 314-1 of the parent 332. For example, parent 332 may already have the first health repository account 314-1 before signing up for the first account 338 at the connection component 302. In other implementations, as the parent 332 is signing up for the first account 338, the parent may be redirected to the health information repository 312 to also sign up for the first health repository account 314-1. In other implementations, the parent may sign up for the first health repository account 314-1 after signing up for the first account 338 at the connection component. Also, according to some implementations, the parent uses the same credentials, such as the same login ID and password, for both the first account 338 on the connection component and the first health repository account 314-1. This enables a user to be redirected from an account at the connection component to a corresponding account at the health repository, and vice versa, without requiring additional login.

Further, one or more records in the first health repository account 314-1 may map to the first account at the connection component 302. Thus, a parent record 340 may be created at the connection component 302 that corresponds with a parent health record 342 at the first health repository account 314-1, and a child record 344 may be created at the connection component 302 that maps a child health record 346 at the first health repository account 314-1. Thus, all or a subset of the records in the first health repository account 314-1 may be mapped to the first account 338 at the connection component 302.

In addition, grandparent 336 may also access patient portal 322 for creating a second account 348 that corresponds to a second health repository account 314-2, such as in the manner described above. A grandparent record 350 in the second account 348 may correspond to a grandparent record 352 in the second health repository account 314-2.

Before permitting parent 332 to access patient information, such as parent visit records 354 in the database 306, the connection component 302 may require the parent 332 to provide information for positively matching and linking the parent to the parent visit records 354. Thus, the connection component 302 may present an interface to the parent 332 that requests identification information from parent 332 in order to match parent 332 with identity information corresponding to parent visit records 354 maintained in the hospital database 306. Thus, the identification information obtained from parent 332 by the connection component 302 may be used to perform matching and linking for securely matching an identity of parent 332. Further, when the identity of parent 332 has been positively matched using first account 338, the hospital visit records 354 of parent 332 can be linked with the parent health record 342 at the health information repository 312 and the parent record 340 in the first account 338 provided by the connection component.

During the matching, parent 332 may be asked to provide a variety of identification information for verifying the identity of parent 332. In some implementations, hospital 308 may provide optional manual oversight 356 during the matching and linking in which hospital staff verify and ensure that the person seeking access to the parent visit records 354 is in fact the correct person. After parent 332 has been matched to the parent record 340, the parent record 340 in first account 338 is linked to the parent visit records 354 so that parent 332 is able to access the parent visit records 354 through first account 338. Furthermore, following linking, parent's health record 342 in the first health repository account 314 is linked to parent visit records 354, so that parent visit records 354 may be automatically transferred to parent health record 342 at health information repository 312.

In addition, parent 332 is able to provide identification information for child 334 to the connection component 302 for matching an identity of the child 334 to identity information maintained in the hospital database corresponding to child visit records 358, and for linking the child visit records 358 to child health record 346 in the first health repository account 314-1. Consequently, this action results in the child visit records 358 being accessible to parent 332 through the first account 338 and also available for delivery to and accessed through the child health record 346 in the first health repository account 314-1.

Furthermore, following the matching and linking of the parent's identification information, the parent 332 may submit a request specifying one or more care providers to access the parent visit records 354. Similarly, following matching and linking of the child's identification information, parent 332 may submit a request to authorize one or more care providers 326 to access the child visit records 358. The component authorized operator 330 can review these requests using the operator interface 328 for deciding whether to approve the requests. For example, in some cases, the hospital staff may deny this access request for various reasons, such as a particular care provider 326 not being registered with hospital 308, or the like.

Additionally, it should be noted that read and write privileges might be required for executing matching and linking, and thereby for requesting access for a care provider to a particular record. For example, since the grandparent has read-only access to the child health record 346, the grandparent is unable to perform matching and linking for the child health record 346 to the child visit records 358. Further, since the grandparent has read-only access, the grandparent cannot specify care providers to access the child visit records 358. Consequently, according to some implementations, a user that has read-only access to a particular record is not able to perform matching and linking for that record or authorize a care provider to have access to that record. On the other hand, if the grandparent has both read and write access, the grandparent is able to specify care providers that can access the child visit records 358 and the grandparent could also carry out matching and linking if matching and linking had not already been performed by the parent.

Implementations herein provide a connection component 302, which may also correspond to the connection component 106 described above, that is a multi-record application for hospitals to provide to their patients so that patients can perform a number of different activities. For instance, the connection component 302 may be configured to provide access to a patient's hospital visit information that is gathered and aggregated from a number of different hospital information-technology systems and make this information available to the patient and the patient's care providers. The connection component 302 also may enable the patient to view, store and/or share information for each hospital visit from any computing device with Internet access or other access to the connection component 302, such as through a local network, etc. For example, hospital visit records can include dates of admittance and discharge, a discharge summary write-up, lab results, prescriptions and pharmaceutical information, and the like. Additionally, the connection component 302 may enable patients to pre-register for hospital visits online using electronic personal health information stored in the patient's health repository account 314, which speeds up the preregistration process while also helping to ensure consistency of information provided by the patient over time.

Accordingly, the connection component 302 can enable patients to connect or link their health repository accounts and connection component accounts to patient records inside the hospital, and stored in the database 306 through patient matching and linking Through this linking, a patient may use the patient's health repository account to receive patient records from the hospital database. Further, through linking of the connection component account, the patient can access and view the patient records, manage access by care providers, and the like. Consequently, following a secure verification process, implementations provide a front-end user interface 320 that can access the back end hospital database for providing direct access to patient hospital visit information. Additionally, while some implementations herein are described in the context of the system of FIGS. 3A-3B for explanation purposes, the implementations herein are not limited to the particular configuration of the system 300, but extend to additional system implementations and configurations.

### Interfaces

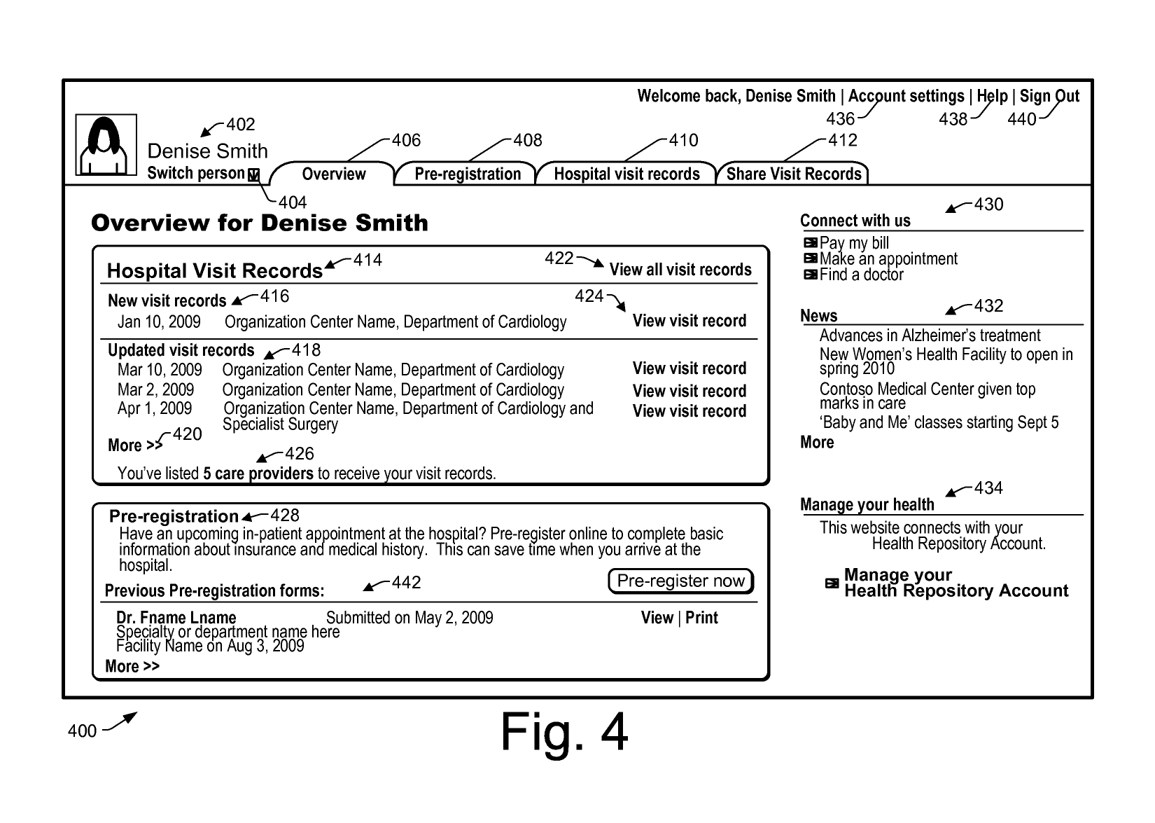

FIG. 4 illustrates an example of an overview page 400 of the connection component user interface for presentation to a user upon login to the patient portal 322 of connection component 302. Overview page 400 includes an identification 402 of the patient record that the user has logged into. In the illustrated example, the identification 402 includes an image and the name of the patient, although more or less information may be provided. Furthermore, because an account can be linked to multiple patients, there is an option 404 to switch from the current patient to another patient included in the account. For example, a parent may initially login and then switch to a child's account, or the like. The connection component interface may include a plurality of tabs for accessing various different features and functions available through the patient portal 322. The illustrated example includes an overview tab 406, a preregistration tab 408, a hospital visit records tab 410, and a share visit records tab 412. When the overview tab 406 is selected, an overview of the patient's account is presented, as illustrated in FIG. 4. The overview includes at least a partial listing of hospital visit records 414 for the patient, such as new visit records 416, updated visit records 418, an option to view more visit records 420, and an option to view all visit records 422. Furthermore, links 424 are provided to view each listed visit record.

In addition, overview page 400 may also provide a message or other indication of how many care providers have been specified to be able to receive the patient's visit records, and a link 426 may be provided to view the enabled care providers. Additionally, a pre-registration area 428 may be provided as a convenient link to the pre-registration page 408. A plurality of other links may also be included on the overview page, for example, internal links 430, such as for paying a bill, making an appointment, or finding a doctor; news links 432, a link 434 to the patient's health repository account, a link to account settings 436 for the connection component account, a help link 438 and a sign out link 440. Further, the pre-registration area 428 of overview page 400 may show any previous or active pre-registration forms 442 that this patient may have.

### Visit Record Access

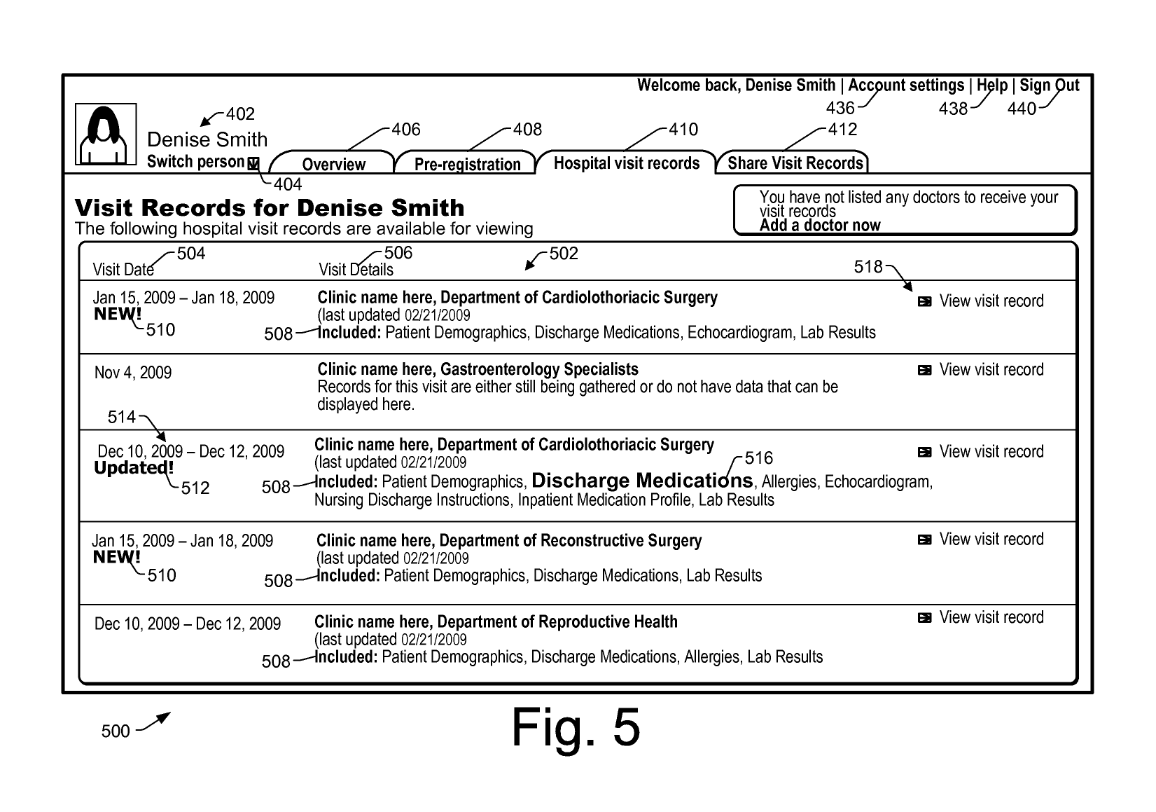

FIG. 5 illustrates an example of a visit records list page 500 of the connection component user interface provided by the patient portal 322, such as when the user selects the hospital visit records tab 410 in the connection component interface. The hospital visit records list page 500 includes a listing of hospital visit records 502 for the selected patient. In the illustrated example, the hospital visit records are listed according to visit date 504 and corresponding visit details 506. Under the visit details 506, for each visit record listed, a clinic name and department may be provided, along with a listing of reports 508 included in the hospital visit record. In some implementations, the listing of reports 508 for each visit record may be dynamically generated depending on which reports are currently available for inclusion in each visit record. Thus, the listing of reports 508 for each visit record may be created even before the visit record itself has been created.

Visit records 502 may include a status indicator, such as a new record status indicator 510 for indicating a new hospital visit record, and an updated status indicator 512 indicating that a portion of the particular visit record has been updated relative to the last time that the patient viewed the particular visit record. In the example of FIG. 5, the hospital visit record 514, dated Dec. 10, 2009-Dec. 12, 2009 includes updated status indicator 512 that indicates that the visit record 514 has been updated. The visit details 506 of the visit record can indicate which portion of the visit record has been updated compared to the remainder of the details of the hospital visit record. Thus, in the illustrated example, the “discharge medications” report 516 of the reports 508 included in the hospital visit record 514 is highlighted, enlarged, color-coded to match the update indicator 512, or otherwise visually indicates that this report 516 of the hospital visit record 514 has been updated since the last time this record was viewed by the patient.

In order to provide the update identification feature, implementations of the connection component 302 herein may maintain metadata for each hospital visit record. The metadata for each hospital visit record may include a date indicating the last time that the hospital visit record was viewed by the patient. The metadata for the hospital visit records further may maintain dates for each report 508 or other portion of each hospital visit record indicating the date of the most recent update to each report 508 or other portion of each hospital visit record. The connection component 302 may then use this stored metadata information to compare the date on which the hospital visit record 514 was most recently viewed with the date of any updates to the hospital visit record 514 for determining which portions of the hospital visit record 514 have been updated since the last time the patient viewed the hospital visit record 514. The connection component 302 may then indicate which portions of the hospital visit record 514 have been updated since the last time the patient viewed the hospital visit record, by providing an indication of the update in the summary displayed for the particular record 512 in the visit details 506.

Accordingly, the list of hospital visit records 502 indicates a status, summary and date for each listed hospital visit record. For each hospital visit, the hospital visit records available for viewing are shown in this summary style list to enable the user to quickly scan the available hospital visit records and any status indicators. For each visit record entry, a summary of the visit record can be displayed in the list including information such as the department in the hospital that was visited, other data included in the hospital visit record, such as discharge summary, operative report, lab reports etc., whether the stay was inpatient or outpatient, and when the information in the hospital visit record was last updated. Additionally, if information is not available for a particular visit but the hospital database has a record of an admittance or discharge event occurring then that visit record date can still be displayed to the user along with a flag such as “data unavailable,” “data still being gathered,” or the like. In addition, if an admittance notification is processed by the hospital database system and one or more hospital visit records pertaining to that admittance are available, but the patient is still receiving treatment inside the hospital, a partial visit record can still be made available to be viewed through the patient portal 322 through dynamic generation of the hospital visit record, as mentioned previously. Consequently, it is not necessary for the patient to have been discharged for the visit record to be created and available for access on the connection component 302.

Each visit record displayed in the list of visit records 502 may include a corresponding view-visit-record link 518, which may be selected by the patient to view a particular visit record. When a link 518 is selected to view a particular one of the visit records 502, according to some implementations herein, rather than providing a stored static document, the visit record may be dynamically generated when the request to view the visit record is received by the connection component. Thus according to these implementations, the information contained in the visit record is gathered from various sources and combined to create an up-to-date and current instance of the selected visit record. For example, as described above, data feeds from multiple sources 308 may be gathered, such as from a plurality of different storage locations used by different departments of the hospital, and this information can be included in the hospital visit record when compiling the requested visit record and providing the visit record to the requesting party. In some implementations, the connection component's data aggregation component 332 may query relevant tables for data on the selected visit record. The data is assembled to generate a CCR or other visit record which is then provided in response to a view request. Thus, the visit record presented may contain the latest information available regarding the patient's visit.

Additionally, the connection component 302 is able to use aggregation component 332 to gather and provide historic visit records that were present in the hospital database 306 before the connection component 302 was placed in communication with the hospital database 306. Thus, the connection component, by accessing the back-end database is able to providing direct access to patient hospital visit information that include historic visit information dependent only on amount of information available in the database 306.

Further, in some implementations, the connection component 302 may automatically deliver a visit record to a linked external account, such as the patient's health record in the health information repository 312 or to the patient's connected care providers. For example, the connection component 302 may automatically generate and send a CCR based on business rules, such as when the reports for the CCR have reached a predefined level of completeness.

In addition, patient visit records, such as CCRs, that have been generated either in response to a user request or based on business rules may be cached and maintained in database 306. This caching can provide quicker response to a user request to view a patient visit record. Also, prior to providing a cached visit record, the connection component can use the date metadata discussed above to check to make sure that the cached visit record contains the latest information. If the particular visit record has been updated between the time it was cached and the time of the request, a new visit record may be generated instead of providing the cached visit record to the user.

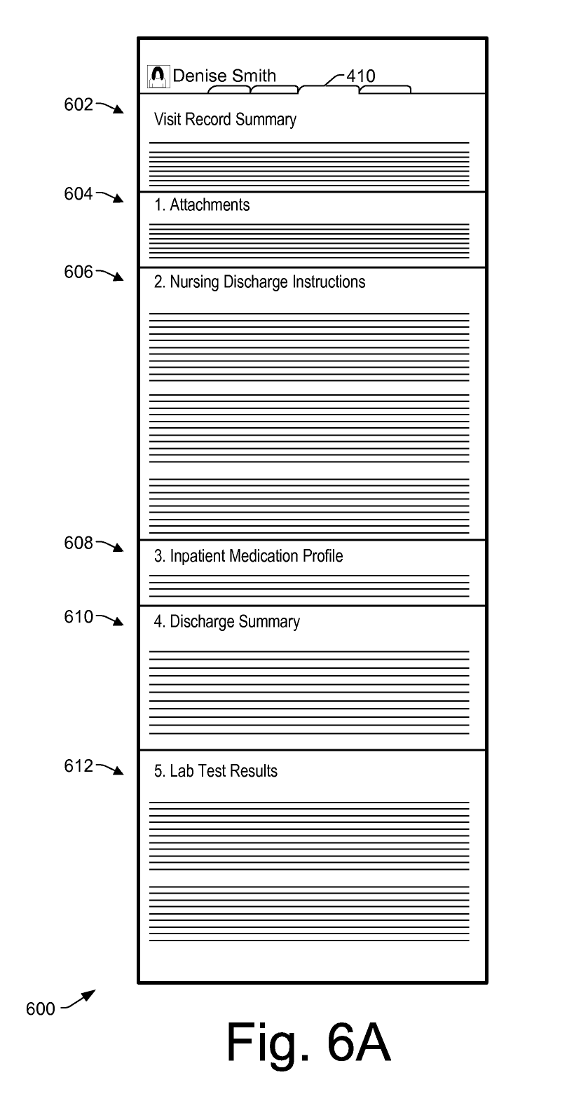

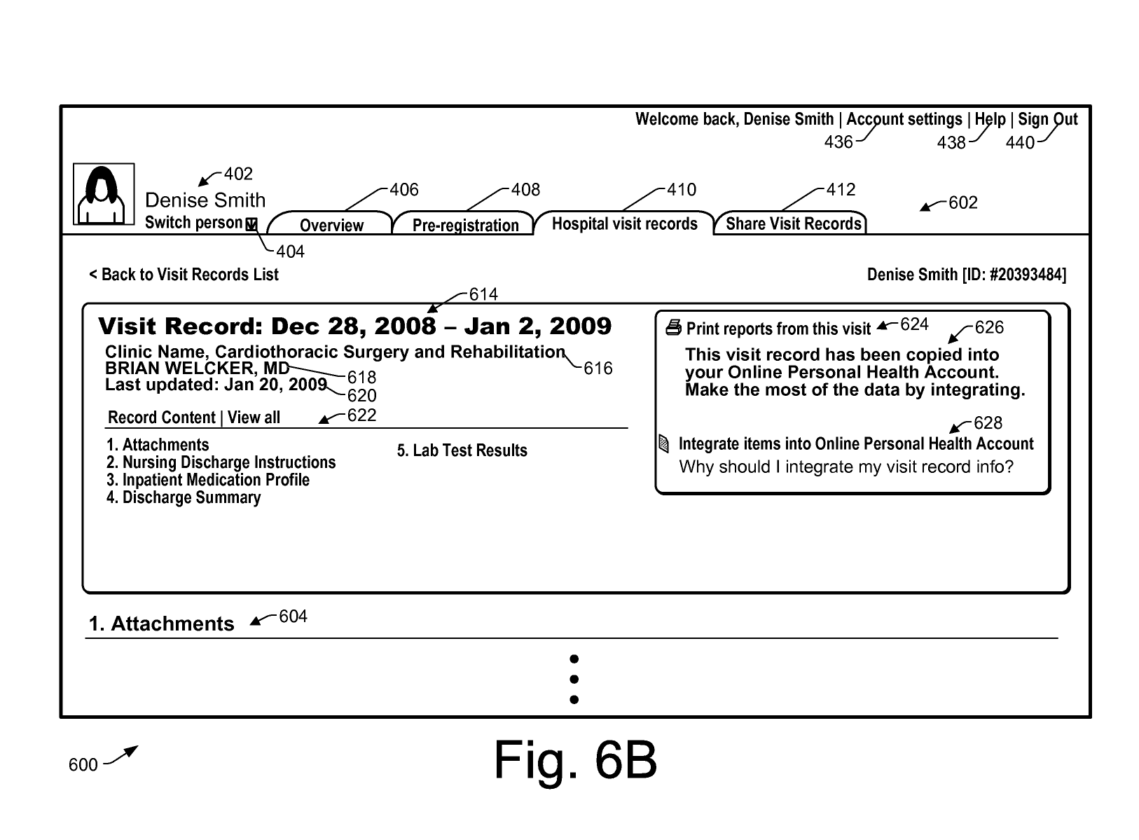

FIGS. 6A-6B illustrate an example of a configuration for a visit record 600 that may be provided to a patient or authorized care provider according to some implementations herein. The example visit record 600 is depicted as a continuity of care record (CCR) hospital visit record, although other formats for hospital visit records, such as a continuity of care document (CCD), or other suitable format, may be used in the implementations herein. Consequently, while some implementations are described using the example of a CCR as a hospital visit record, implementations herein are not limited to the use of CCRs as the hospital visit records.

As mentioned above, a CCR is a core data set of the relevant administrative, demographic, and clinical information and facts about a patient's healthcare, typically covering one or more healthcare encounters. The CCR enables one healthcare practitioner, system, or setting to aggregate the pertinent data about a patient and forward this information to another practitioner, system, or setting to support continuity of care. The CCR specification stipulates the use of XML coding to ensure interchangeability of electronic CCRs. Thus, when prepared in a structured electronic format, adherence to an XML schema may be specified to support standards-compliant interoperability. In addition, conditions of security and privacy for a CCR instance may be established in a manner that allows only properly authenticated and authorized access to the CCR document instance or its elements.

As illustrated in FIG. 6A, hospital visit record 600 may include a number of different portions such as a visit record table of contents and summary 602, list of attachments 604, nursing discharge instructions 606, inpatient medication profile 608, discharge summary 610, and lab test results 612. Further, while particular examples of different visit record portions are illustrated in FIG. 6A, the actual information included in a particular instance of a hospital visit record 600 will vary depending on the medical treatment received by the patient. Further, the content of the hospital visit record 600 may be configurable by a particular hospital depending on how the hospital is set up.

FIG. 6B depicts a detail view of the visit record table of contents and summary 602 of the visit record 600. The visit record summary 602 may include a visit record identifier 614 that identifies the date of the visit record, the clinic name 616 within the hospital that is the source of the visit record, the responsible physician 618, the date on which the record was last updated 620, and a listing of contents 622 of the visit record. Furthermore, the visit record table of contents and summary 602 may include a print option 624 for the patient to print all or part of the visit record, and a notification 626 that the visit record has already been copied into the health repository account of the patient.

Accordingly, an indication, such as notification 626 can be provided to the patient to indicate that the particular visit record is already present in the patient's health repository account. For example, as discussed above, the connection component may be configured to automatically push the visit record into the health repository account when the visit record has reached a specified level of completeness. Further, the patient may copy the visit record manually if not pushed automatically. This provides a consolidation between the enterprise data of the hospital and the patient's personal health data in the health information repository 312, and thereby provides automatic assistance to the patient in the management of the patient's health data. Additionally, if the visit record is not yet present in the patient's health repository account, a button may be displayed to the patient in conjunction with the hospital visit record for manually copying the hospital visit record to the patient's health repository account.

In addition, an integration option 628 may be provided to integrate items from the visit record 600 into the patient's health repository account record. For example, integration option 628 may be included as a link in the visit record summary 602. Selection of this link enables some of the information contained in the visit record 600 to be integrated into other parts of the information contained in the health repository account record, rather than merely storing a copy of the visit record at the health repository account 316. For example, the inpatient medication profile 608 and the lab test results 612 may be data types that are recognized by the health information repository in a patient visit record received from the connection component. These data types may be automatically stored with other lab results and medication information contained in the health repository account health record for the particular patient. This integration function may be enabled by using corresponding matching data types in both the hospital visit record 600 and the personal online health repository 314 to enable data from matching data types to be automatically integrated based on schemas for data contained in the data types. Consequently, implementations herein provide for automatic separation, extraction and integration of healthcare information contained in a hospital visit record in a hospital database into a personal online health account record managed by the patient.

### Sharing Access

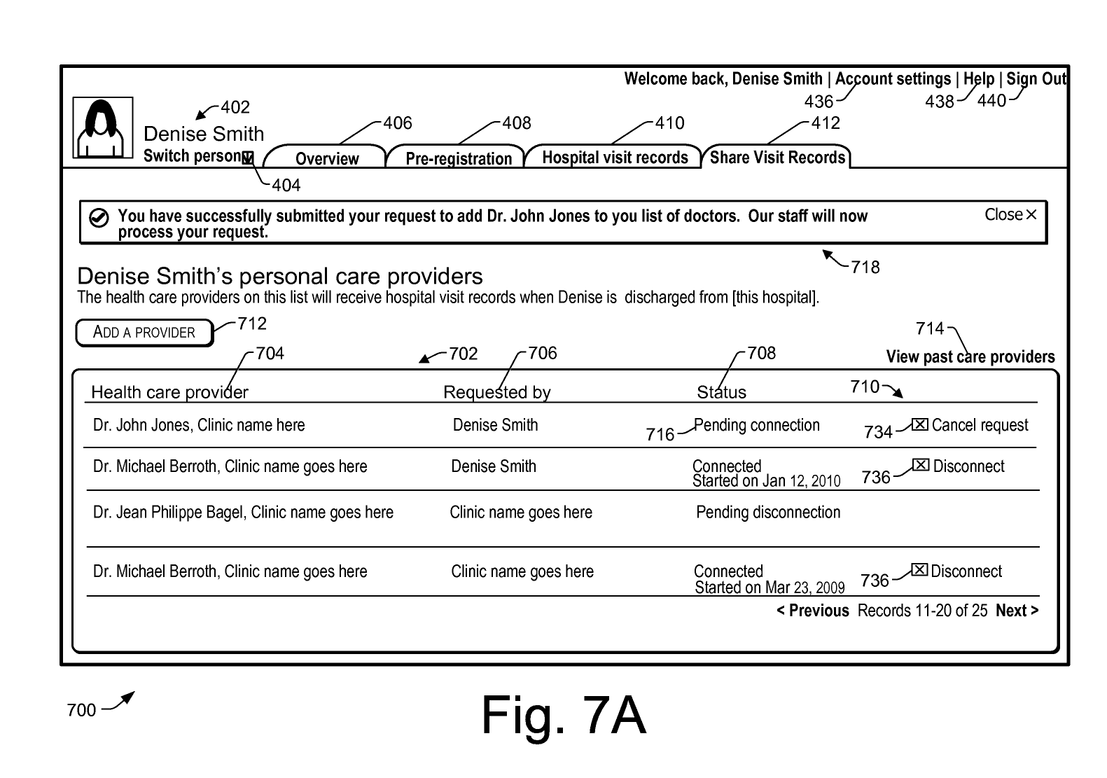

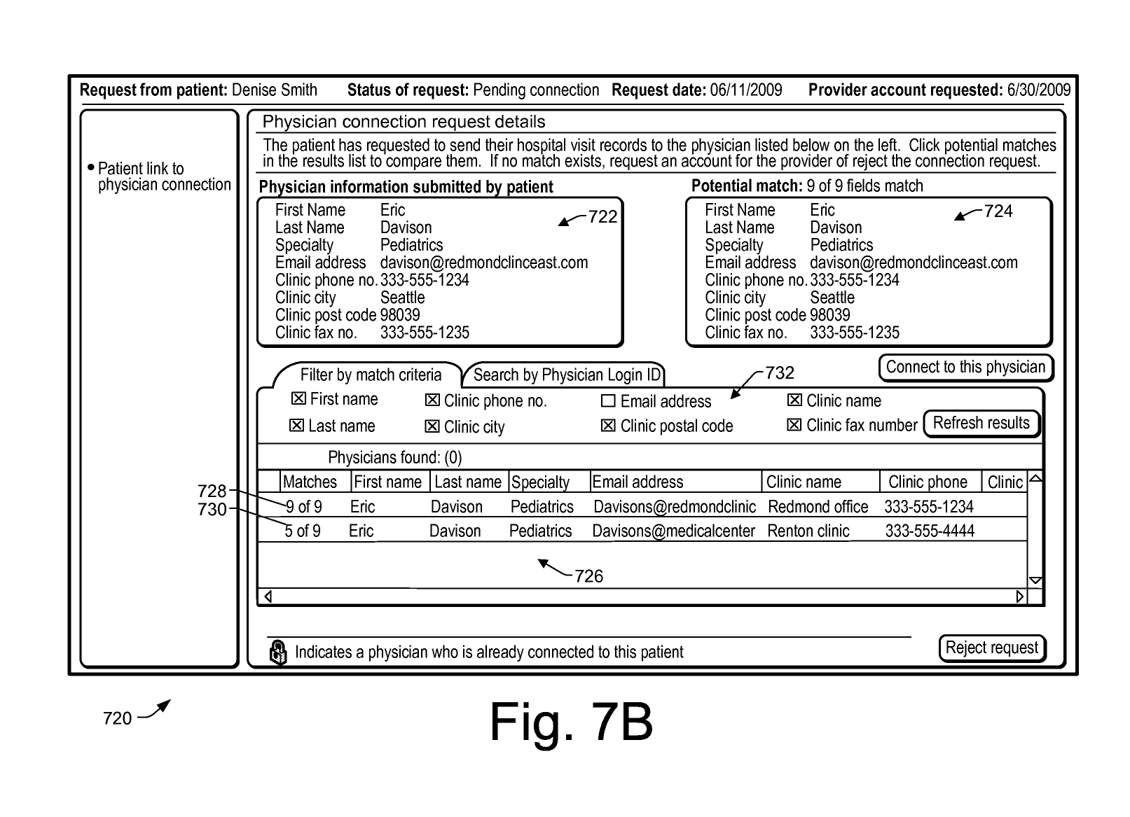

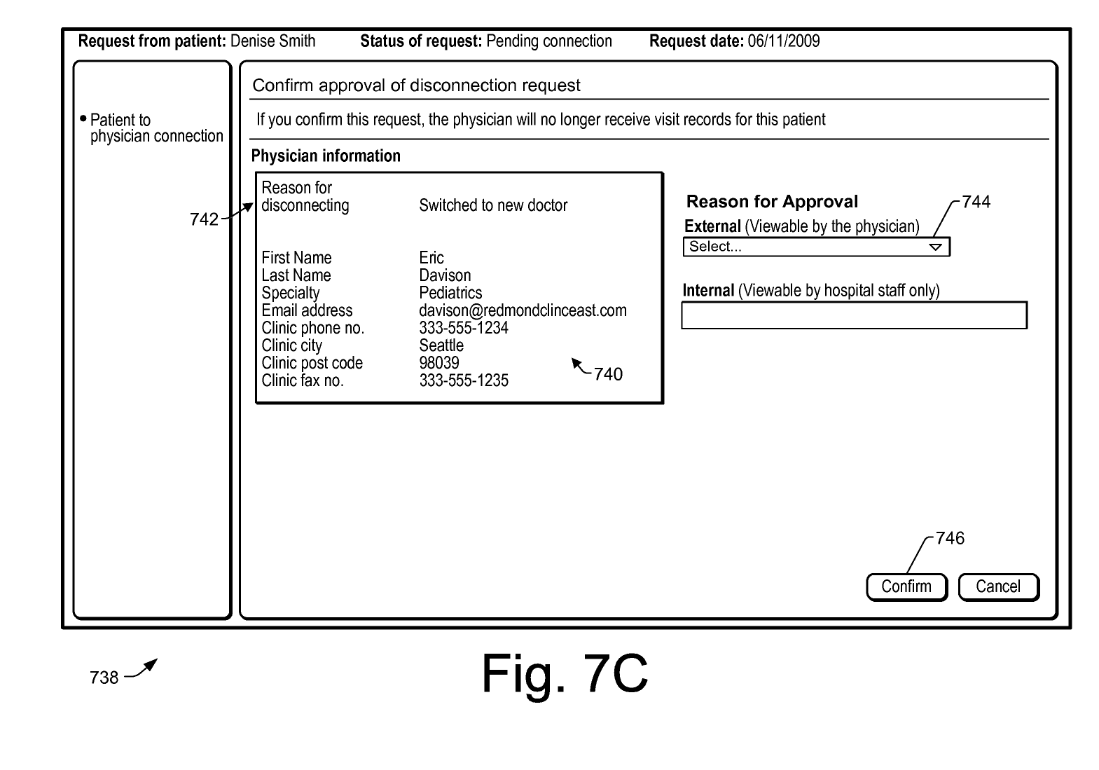

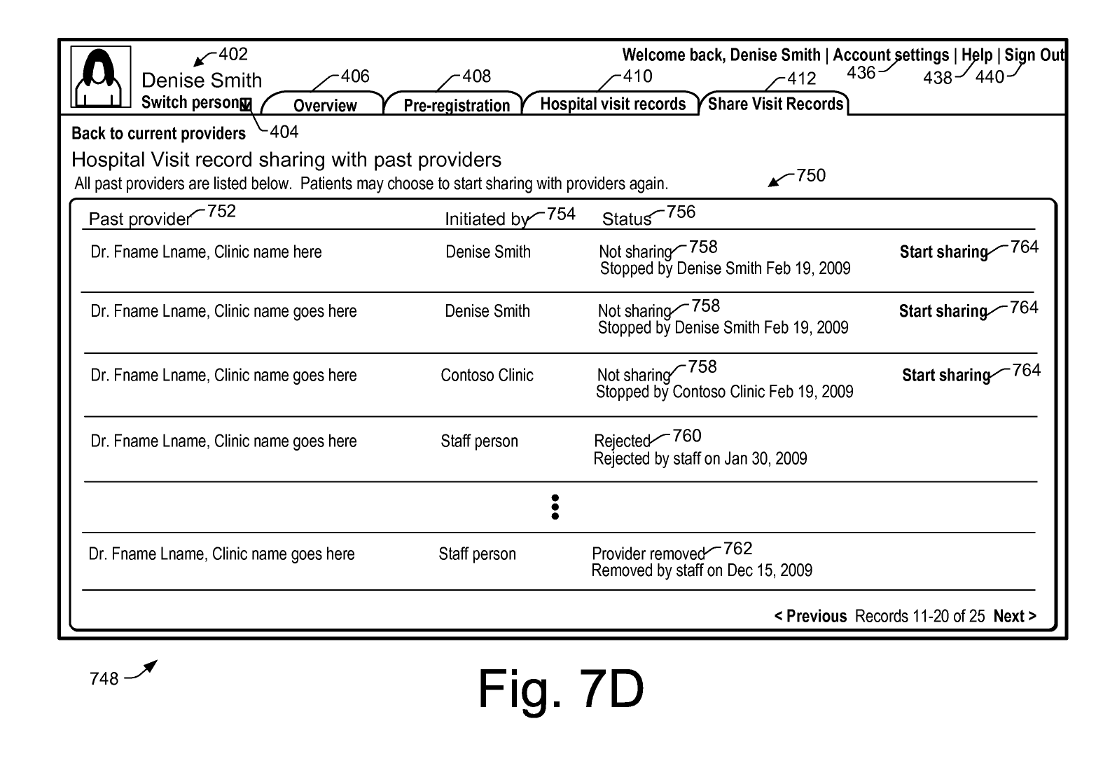

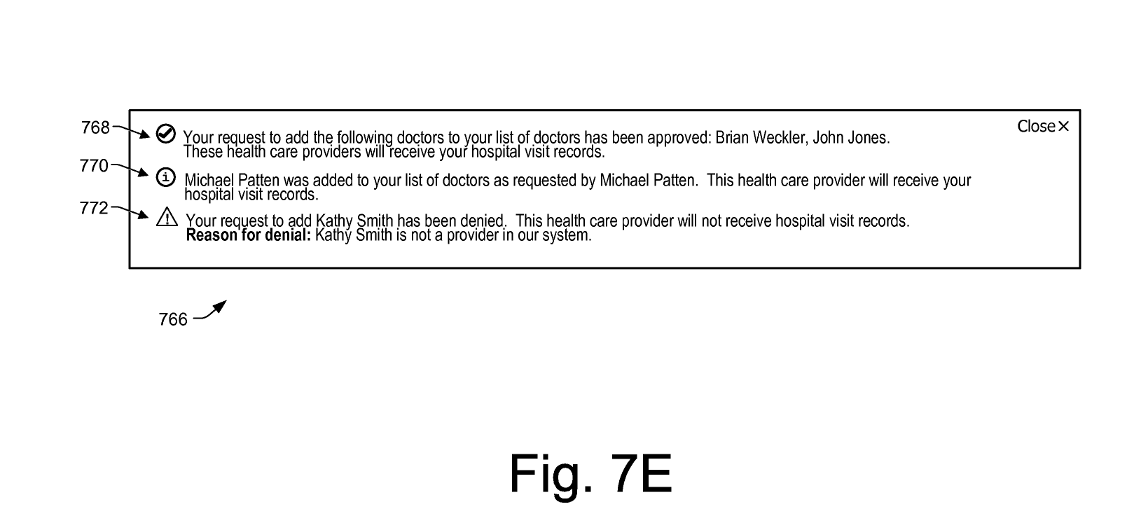

FIG. 7A illustrates an example of a share-visit-records page 700 of the connection component user interface for enabling a patient to identify to the hospital staff one or more care providers to access and share the patient's hospital visit records. To enable a care provider to electronically retrieve the patient's data from the hospital, the patient may provide the particular care provider's information, such as name, e-mail address, and other requested information in a request form submitted through the patient portal 322. As discussed below, the request is subject to hospital staff review and approval prior to allowing the patient information to be communicated to the particular care provider.

When a care provider has been connected to sharing status, the care provider may then receive and view the patient hospital visit records. For example, through the referral portal 324 discussed above, a care provider may establish their own connection component account to access patient information in the hospital database 306. Thus, following a submission of required care provider identification information in a secure matching process similar to that for matching a patient, as described above, the care provider is able to receive patient information for those patients for which the care provider has been approved by the hospital. For example, subject to hospital staff approval, the care provider can be specified by a patient to receive the patient's visit information, as discussed above. Further, subject to staff approval, the care provider may submit on their own initiative a request to access visit records for a particular patient. For example, a patient who does not use a computer may authorize a care provider to access his or her visit records. Additionally, in some implementations, the hospital staff may connect visit records to a care provider based on instructions received external to the connection component 302, such as by telephone, fax or written instructions from a doctor, patient, or the like.

As illustrated in FIG. 7A, share-visit-records page 700 may include a list of care providers 702 displayed to the patient for managing the care providers able to access the patient's hospital visit records. For example, the care providers may be listed by healthcare provider name 704, an indication of a source of a request 706, a status 708 of the corresponding care provider, and selectable options 710 for managing the status of the corresponding healthcare providers. Further, an add provider button 712, or the like, may be provided for enabling the patient to add additional care providers and a past provider link 714 may be provided for enabling the patient to view care providers that have previously been connected for record sharing access.

As mentioned above, when a patient desires to add a care provider, the patient submits information to identify the care provider to the connection component such as through the use of an online form provided by through the patient portal 322, or the like. When the online form has been submitted, a pending connection status indicator 716 indicates that a sharing request has been submitted by the patient and that the request is still waiting for hospital staff approval. For instance, suppose that the patient has submitted a request to add Doctor John Jones as a care provider able to access the patient's hospital visit records. In response to receiving the request, the connection component 302 may provide the patient with a message in a closeable message window 718 overlaid on the connection component interface that indicates that the request has been submitted successfully and the hospital staff will review the request.

FIG. 7B illustrates an example of the hospital staff's view of a patient-care provider match request 720 submitted to the hospital. Care provider information 722 submitted by the patient is automatically compared by the connection component with care provider information 724 maintained by the hospital database or the connection component. The connection component may automatically identify one or more care providers 726 that match the care provider information 722 submitted by the patient.

In the illustrated example, a first care provider 728 matches nine out of nine information categories, while a second care provider 730 only matches five out of nine information categories. The hospital staff is able to review both of these care providers 728, 730 to ensure that the correct care provider is selected for permitted access to the patient's hospital visit records. Alternatively, when there is an exact match such as in the case of first care provider 728, the connection component may be configured in some implementations to automatically connect the care provider that exactly matches all specified categories. Additionally, the hospital staff may use a filter 732 as assistance for identifying possible matches. For example, by deselecting one or more of the categories in filter 732 and refreshing the results, any care providers that meet the revised matching criteria will be listed. If the hospital staff is unsure of which care provider is the correct care provider the hospital staff may investigate further before granting access to any care provider. This ensures that the patient's personal information is properly protected. Furthermore, when a share request has been approved, a confirmation message similar to closeable message window 718 discussed above may be added by the connection component to the sharing request page 700, the overview page 400, or the like.

Additionally, a patient may cancel a record sharing request before the request has been confirmed, such as by selecting a cancel request link 734, as illustrated in FIG. 7A. When the request is canceled before confirmation by the hospital staff, the request is removed from a queue in operator interface 328 of the connection component.

Further, a patient may choose to stop sharing with a care provider at any time, such as by selecting a disconnect link 736, as also illustrated in FIG. 7A. For example, as illustrated in FIG. 7C, when a request to disconnect a care provider is made, the request may be submitted to the hospital staff and presented in a request page 738 requesting approval from the staff of the disconnection of the care provider. For instance, the disconnect request may be made by the patient or by the care providers themselves. The disconnect request page 738 provides identification information 740 to the hospital staff that identifies the care provider to be disconnected. Furthermore, a reason for disconnecting 742 may be provided by the patient or the care provider and included with the request to disconnect. When the patient provides a reason for disconnection, the reason for the disconnection request may optionally be provided to the care provider by a selectable menu item 744. The hospital staff may also provide a reason that is only viewable internally. When the request to disconnect is approved by the hospital staff, the hospital staff may select a confirm button 746 on the displayed disconnection request page 738 to complete the disconnection of the care provider. Attempts by the disconnected care provider to access the patient's hospital visit records will thereafter be denied by the connection component.

When the patient desires to view care providers that have been connected in the past, such as for reconnecting to a past care provider, the patient may select the past provider link 714 in FIG. 7A, which results in display to the patient of a past care providers page 748 in the connection component interface, as illustrated in FIG. 7D. A list of past care providers 750 may be displayed according to name of the provider 752, the entity that initiated the disconnection from the provider 754, and the status of the provider 756. Care providers whose status is merely “not sharing” 758, rather than “rejected” 760 or “provider removed” 762, may be reconnected by selecting a corresponding start sharing link 764. However, care providers whose status is rejected 760 or removed 762 do not include the option to start sharing again.

Accordingly, implementations may provide for a number of different statuses 708, 756 for care providers that describe, subject to staff approval, whether or not the care providers may access the patient's hospital visit records. For example, as mentioned above, a “pending connection” status indicates that a sharing request has been submitted by a patient and that the request is still waiting for approval. A “connected” or “sharing” status indicates that a request to add the care provider has been approved by the hospital staff, and the approved care provider is able to access the patient's hospital visit records. A “disconnected” or “not-sharing status” indicates a care provider is no longer able to access the patient's hospital visit records. This status may be initiated by the patient or by the care provider or the hospital staff. A “rejected” status indicates that the hospital staff has rejected a patient's sharing or disconnection request for a particular care provider. For example, the requested care provider may not have privileges at the hospital. A “provider removed” status may indicate that the care provider was removed by the hospital staff, such as for losing hospital privileges or for various other reasons. Rejected or removed care providers typically are not provided with an option to start sharing again, and requests by patients to provide access to patient hospital visit records to these care providers may be rejected by the hospital staff.

Furthermore, as illustrated in FIG. 7E, a provider patient connection status messaging feature provides a way for patients to be notified of changes in patient-provider connection status through the use of closeable message windows 766 and 718 (discussed above with respect to FIG. 7A). For example, a message window such as message 766 or 718 may be displayed upon the initial login to the patient portal 322 by a patient for displaying a status of any care provider requests or changes. For example, the messages 766, 718 may be displayed in the overview page 400, as mentioned above with respect to FIG. 4, and/or displayed when the shared visit records tab 412 is selected and page 700 is displayed. Thus, the patient is able to submit a request to the connection component indicating that the patient would like hospital visit records to be provided to a particular care provider. When a requested connection has been approved, the connection to the specified care provider is made in the connection component, and a notification message may be shown on the patient's connection component interface confirming or denying the connection request. For example, upon login to the patient portal 322, the patient may be notified by the connection component regarding rejected or accepted connections and the like.

Further, if multiple messages of the same type are to be provided, the multiple messages may be concatenated into a single message, such as message 768. For example, if connection to two care providers has been granted, the two messages may be concatenated into a single message, such as “Your request to add the following care providers has been approved:” followed by a listing of the care providers, or the like, as shown by message 768. Thus, multiple messages for multiple statuses may be triggered by events occurring at different points in time, and the resulting messages may be combined into a single message that is provided to the user when the user next accesses the connection component interface, such as just following login. Additionally, if multiple messages of different types are to be provided, they may be displayed together in a single closeable message window 766. In the illustrated, example message 770 shows that a care provider was added by the care provider's request, and message 772 shows that a request to add a care provider was denied. These two messages 770, 772 are combined with message 768 to deliver all the messages 768, 770, 772 in a single closeable window that may be overlaid on a user interface page. This messaging arrangement enables patients to be quickly and conveniently notified of any changes regarding care providers able to access their hospital visit records. Consequently, implementations herein provide a messaging interface that enables multiple messages of the same type and/or of different types to be displayed together to the user in a single closeable messaging window that may be overlaid on a currently-displayed page or other user interface. The messaging window may be displayed following user login or when the user accesses a particular page to which the messages are relevant.

Control of Multiple Records through Single Account

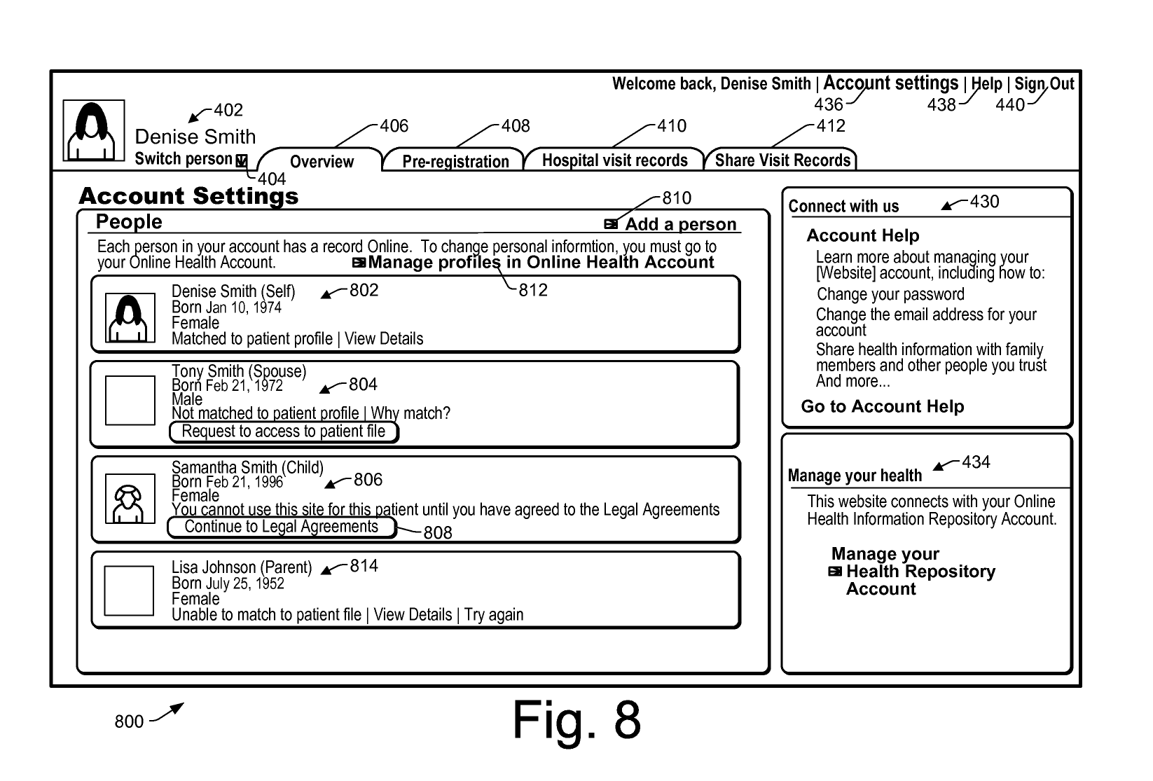

FIG. 8 illustrates an account settings and record selection page 800 of the connection component user interface that may be presented by the patient portal 322 in response to the patient selecting the account settings link 436. As mentioned previously, the connection component permits multiple records for different patients to be managed in the same connection component account. Thus, a patient that is matched and linked in the connection component 302 may include multiple records e.g., an entire family, in a single account accessed by a single login credential. Furthermore, a particular connection component account record can be shared between multiple connection component accounts and when a patient's hospital record has been matched and linked to the patient's health repository account record (i.e., creating a link between the record in the health repository account and the patient visit records in the hospital), all individuals with authorized access to that health repository account record are also able to access the patient's hospital visit records based on the sharing privileges set up in the health repository account (e.g., read-only, read-write, etc.). Consequently, according to implementations herein, a user is able to set up a single connection component account for the entire family based on their health repository account, and may then use their health repository account relationships to establish relationships that are honored by the connection component when interacting with the corresponding hospital visit records. Thus, based on sharing relationships established between health repository accounts, there may be a one-to-many relationship between a single connection component record and multiple health repository accounts.

Further, after the patient has performed a patient match once for a particular online health account record, then all health repository accounts that are able to access that health record are also able to access the hospital visit records for that patient through the connection component. Additionally, the connection component can support the online health account's read-only as well as read/write relationships. Consequently, a patient's health record in the health repository account with read-only rights is not able to initiate a patient match request at the connection component, nor can they save information from the connection component back into the health repository account record. However, a read-only health repository account is able to submit a preregistration, view hospital visit records (if a patient match has already been performed by someone with a read-write access account) and initiate patient-provider connection requests (if a patient match has already been performed by someone with a read-write access account).

In the example illustrated in FIG. 8, Denise Smith's record 802 for the patient Denise Smith has been matched and linked to a patient profile in the database 306, as discussed above, by providing matching information. For example, Denise Smith may correspond to the parent 332 discussed above with reference to FIG. 3B. Consequently, Denise Smith's health repository account parent health record 342 in the health information repository 312 has also been linked to her hospital patient visit records 354 in the hospital database 306. Denise Smith's husband, Tony Smith's record 804, is shown as not having yet been matched to a corresponding patient profile in the hospital database. Further, suppose that Denise is in the process of matching her daughter Samantha Smith's record 806 (corresponding to the child 334 and child record 344 of FIG. 3B), and will be able to provide matching information following selection of button 808 and agreement to the legal agreements. Denise may click on the continue to legal agreements button 808 to proceed with the matching and linking of her daughter's record 806 to the patient visit records of her daughter in the hospital database 306, and thereby matching and linking the patient visit records of her daughter to the corresponding child health record 346 in the health information repository 312. When the steps for submitting the match request have been completed, Samantha Smith's record 806 may show a “match and link pending” status until the matching is approved, either through automated matching an linking executed by the connection component, or through manual matching and linking executed using hospital staff oversight.

In addition, a link 810 may be provided to enable the addition of one or more additional people to the connection component account, for example a parent, additional child, or the like. In some implementations, clicking the link 810 may redirect the user to health information repository 312 for adding a new person's record to the health repository account. Also, because relationships in the health repository account may be used to create corresponding relationships in the patient connection component account, a link 812 may be provided for managing the profiles in the health repository account.

Additionally, the account settings and record selection page 800 may also display unsuccessful match attempts. For example, suppose that Denise Smith attempted to submit matching information for her mother, Lisa Johnson (corresponding to the grandparent 336 in FIG. 3B), but Denise Smith does not have write access to Lisa Johnson's grandparent health record 352 in the health information repository 312, or Lisa Johnson may have already matched and linked the grandparent visit record herself, using the second account 348 and grandparent record 350. Because implementations herein do not permit matching and linking of hospital visit records to multiple accounts or records, and do not permit matching and linking by health repository accounts that do not have write access, the match and link attempt was denied. Thus, Lisa Johnson's record shows that the attempt was unable to match the patient to the file. Other instances of unsuccessful match attempts may be similarly displayed, such as when incorrect information is submitted in a match request.

Relationships between Accounts

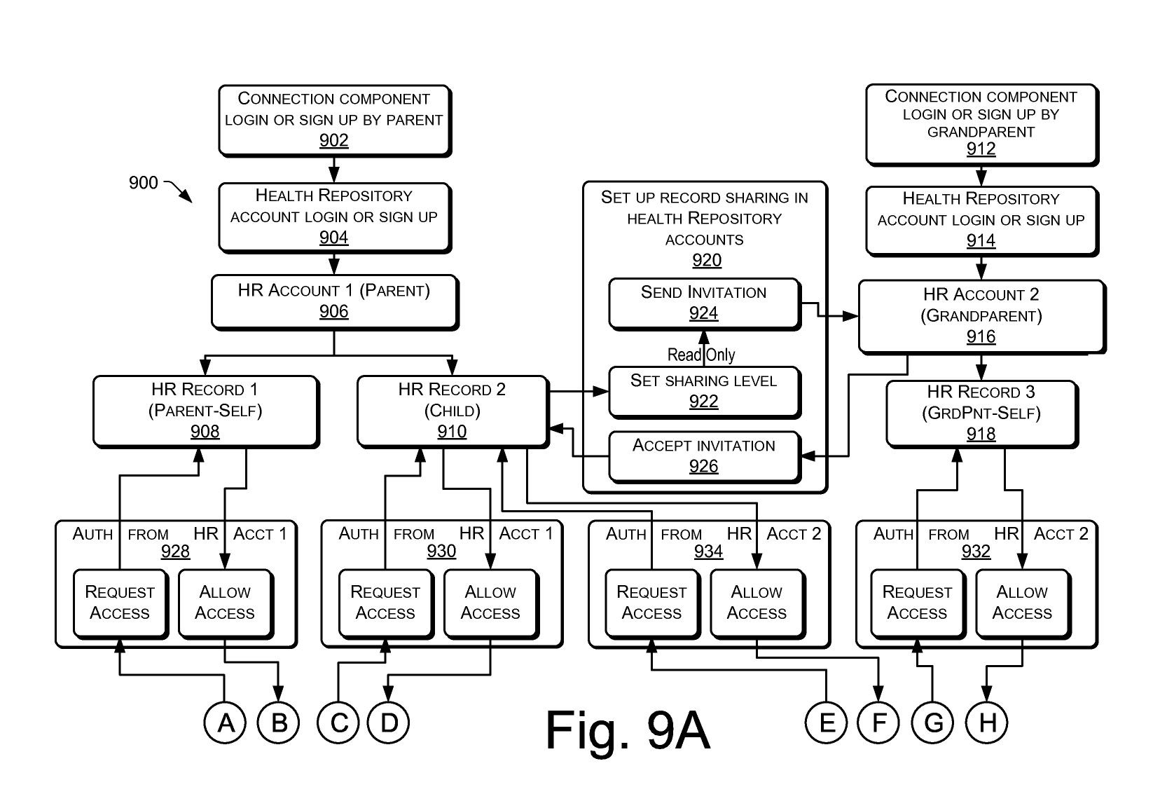

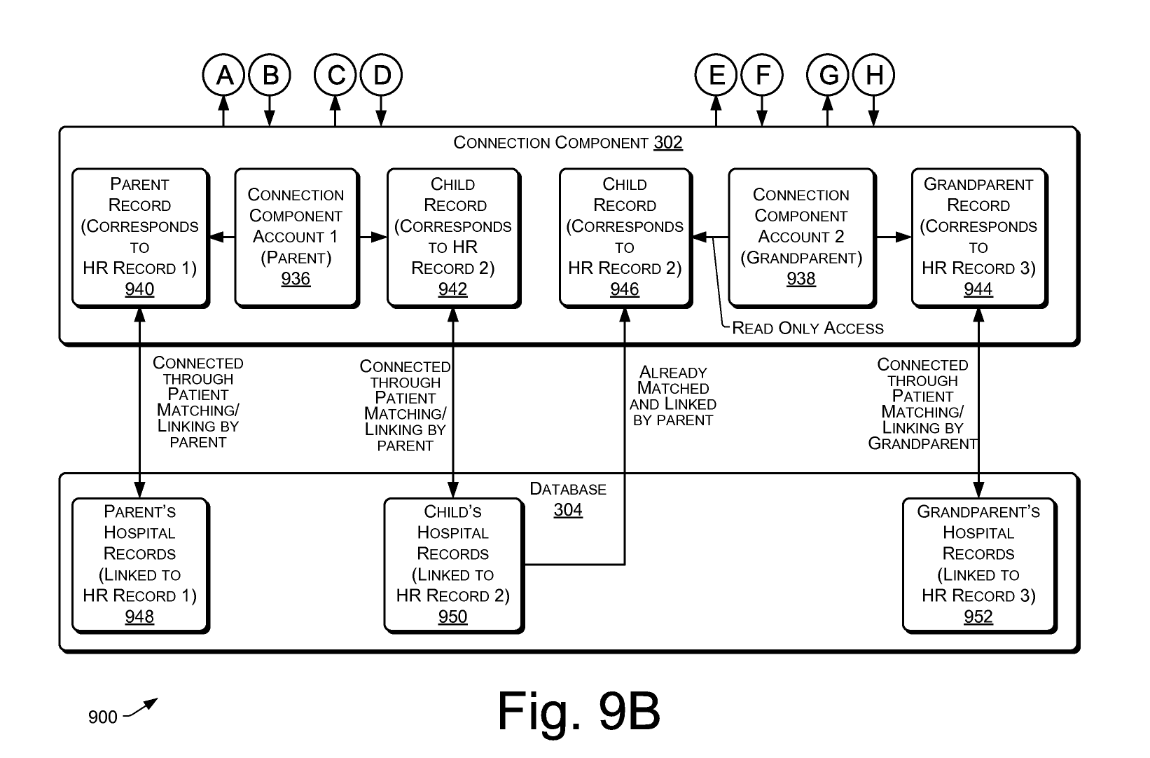

FIGS. 9A-9B depict a block diagram 900 illustrating an example of relationships between account records maintained in the health information repository 312 and the hospital database 306 according to some implementations. Further, the relationships of block diagram 900 may, but need not necessarily, be implemented using the examples of FIGS. 3-8. Consequently, by way of explanation, and not limitation, the process 900 is described in the context of the examples of FIGS. 3-8.

At block 902, based on the example of FIG. 3B, an individual who happens to be a parent logs in or signs up for an account 338 using the connection component 302 of hospital 308. For example the parent 332 may have a child 334 (i.e., the child in this example) and may also have a parent (i.e., the grandparent 336 in this example).

At block 904, as part of the account sign up process, the connection component has the parent also perform operations for obtaining an account on the health information repository 312, if the parent does not already have an account. Thus, the connection component may use the authorization for the health information repository 312 as authorization for login to the connection component 302. Further, the order of blocks 902, 904 may be reversed.

At block 906, as a result of block 904, the parent has a first health repository (HR) account 314-1 (i.e., HR Account 1). Furthermore, as a result of block 902, the parent also has access to a first account 338 on the connection component 302, but has not yet provided matching and linking information to the connection component for accessing the hospital visit records of the parent in the hospital database 306.

At block 908, the health repository account of the parent (HR Account 1) has a parent health record 342 (HR record 1) for storing the health information of the parent.

At block 910, the parent has also included the child in the health repository account 314-1 (HR Account 1), and thus, there is a child health record 346 (HR record 2) included in HR Account 1 for storing the health information of the child. Further, the parent has both read and write access to the health repository account child health record 346 (HR record 2).

At blocks 912 and 914, the grandparent also separately signs up for access to the connection component through a separate second account 348 and for a separate health repository account 314-2 (HR Account 2) on the health information repository.

At blocks 916 and 918 the separate health repository account in the health information repository created by the grandparent (HR Account 2) has a grandparent health record 352 (HR record 3) for storing the health information of the grandparent. Consequently, the grandparent is able to access the connection component 302 and the health information repository 312 using login credentials and an account that are separate from those of the parent. Further, while the grandparent has access to the connection component 302, the grandparent also has not yet provided matching and linking information to the connection component 302 for accessing the hospital visit records of the grandparent in the hospital database 306.

At block 920, the parent decides to allow the grandparent to be able to view or access the child's health information. Consequently, the parent sets up record sharing in the health repository account 314-1 to enable the grandparent to access the child's health information. The access may be both read and write access in some implementations, but in this example the access is for read-only access.

At blocks 922 and 924, the parent sets the sharing level of the child health record (HR record 2) to read-only with respect to the grandparent, and sends an invitation to the grandparent's health repository account (HR Account 2) for sharing the health record of the child.

At block 926, the grandparent accepts the invitation to share the record of the child at a read-only sharing level. Consequently, the grandparent is able to view the health information in the child's health record (HR record 2), but is not able to write to the child's record, such as for storing information therein.

At block 928, as a result of the parent signing up for the health repository (HR) account and the connection component account, the connection component is able to request access and allow access between the records in the health repository account (e.g., HR record 1 of HR Account 1) and corresponding records (i.e., the parent record) in the connection component account. Consequently, the connection component is able to exchange information (i.e., request access, allow access) between the records in the connection component account and the corresponding records in the health repository account. Thus, at block 930, the connection component is authorized to exchange information with HR record 2 of HR Account 1, and at block 932, the connection component is authorized to exchange information with HR record 3 of HR Account 2. Further, at block 934, because HR record 2 is shared with HR Account 2 through the health information repository, the connection component is also authorized to exchange information in a read-only manner with HR record 2 of Account 1 based on the relationship with Account 2.

Referring to FIG. 9B, as a continuation of FIG. 9A, block 936 represents the connection component account (Connection component account 1) created by the parent in block 902, and block 938 represents the connection component account (Connection component account 2) created by the grandparent in block 912.

Connection component account 1 at block 936 has a parent record (corresponding to HR record 1) at block 940 and a child record (corresponding to HR record 2) at block 942. Similarly, Connection component Account 2 created by the grandparent has a grandparent record (corresponding to HR record 3) at block 944 and a child record (corresponding to HR record 2) at block 946. Further, because the grandparent sharing privileges for HR record 2 are limited to read-only in the health repository account, the connection component also limits the grandparent's access to the child record in the connection component account 2.

At block 948, the parent can use the matching and linking process described above to match and link the parent's hospital records to the parent record and Connection component account 1, and thereby link the parent's hospital records to HR record 1 of the parent's health repository account (HR Account 1).

At block 950, similarly, the parent can use the matching and linking process to match and link the child's hospital records to the child connection component record, and thereby to HR record 2 of the parent's health repository account (HR Account 1).

At block 952, the grandparent can use the matching and linking process to match and link the grandparent's hospital records to the grandparent record, and thereby to HR record 3 of the grandparent's health repository account (HR Account 2). Further, because the parent has already matched and linked the child's hospital records to the health repository account of the parent (HR Account 1), the sharing relationship that is established between HR Account 1 and HR Account 2 is given the same status by the connection component as in the health information repository. In this example, since HR Account 2 has read-only status in the health information repository with respect to HR record 2, then read-only status is also granted in the portal account 2 for accessing the child's hospital records. Accordingly, the grandparent is able to view the child's hospital visit records without having to perform patient matching for the child. This trust relationship is mediated through the sharing rules of the health information repository. For example, a read-only account is not able to initiate patient matching, but is able to obtain the benefits of patient linking once the link is in place. Further, under read-only privileges in the connection component, the grandparent is able to create preregistrations for the child, but is not able to save data back into the health repository account. Similarly, while the grandparent is able to view hospital visit records, such as CCRs for the child, the grandparent is not able to copy the CCRs back into the child's health record (HR record 2).

### Data Type for Information Protection

Furthermore, the health information repository may include specific data types that can be used for privacy protection or for use by connection components at their discretion. Thus, within the health repository account, a connection-component-specific data type may be used by the connection component 302 to enable the binding of a single patient identifier to multiple online health repository account and health record identifier combinations. For example, when a health repository account record is used for the first time within a connection component account, that record will be updated with the connection-component-specific data type and optionally digitally signed by the hospital. Upon all future use of the health repository record by a connection component account, the application-specific data type specific to the hospital will have its signature validated prior to use. If the signature of the application-specific data type is found to be invalid, the current value of the application-specific data type may be discarded and a new value may be generated, signed and updated into the record of the health repository account.

In addition, message authentication may be used to detect any tampering with both the data and messages checksums, so as to introduce changes while seemingly preserving the message's integrity. Message integrity may be used to indicate that the data has not been changed, destroyed or lost in an unauthorized manner. Furthermore, signer authentication may be used to indicate that the identity of the signer is as claimed so that a level of trust can be inferred from the information being consumed.

The connection-component-specific data type is an object populated by the connection component with information meaningful to the connection component for managing relationships between patients' records and accounts in the health repository, the connection component and the hospital database. Consequently, the connection-component-specific data type can be used to manage the relationships between accounts for enabling records under each account to be separately identified and managed. Thus, the connection-component-specific data type enables creation of a globally unique identifier for each record that can be used to mark the record so that the connection component can recognize the record, even if the record accesses the connection component from a different account than the account the record was in when the identifier was generated.

The identifiers may also be secured so that only the connection component can access the information and digitally signed the authenticity of the information stored can be verified. For instance, the connection-component-specific data type may be used by the connection component to place an identifier for each record and each account in the connection component, and an identifier for each corresponding visit record in the database 306. For example, the child record 344 in the connection component 344 can be identified by a child record identifier and an account identifier, while the child visit records 358 have a separate identifier. Thus, based on the identifiers, the connection-component-specific data type is used to help direct patient visit records to the correct record in the health information repository.

As an example, if the child health record 346 is moved from first health repository account 314-1 (parent) to the second health repository account 314-2 (grandparent), the record 346 is still recognized as being connected to the child record 344 and the child visit records 358. Thus, the connection-component-specific data type can be used to protect the child visit record from being matched and linked to more than one record in the health repository or in the connection component.

Furthermore, suppose that the grandparent obtains an account at the connection component prior to the parent and uses the child's record to create a pre-registration for the child before the child's record is matched and linked. Then the parent creates a connection component account for the child. Through the connection-component-specific data type identifiers, the child record created by the parent and the child record created by the grandparent are able to be identified as belonging to the same person based on the relationship of the records identified in the health repository account. This enables merging of the pre-registrations that were performed by the grandparent with the patient match details performed by the parent to unify the information for the child record. Further, the grandparent is able to avoid having to perform matching as the sharing relationship established between accounts in the health information repository can be supported by the connection component.

### Example System Architecture

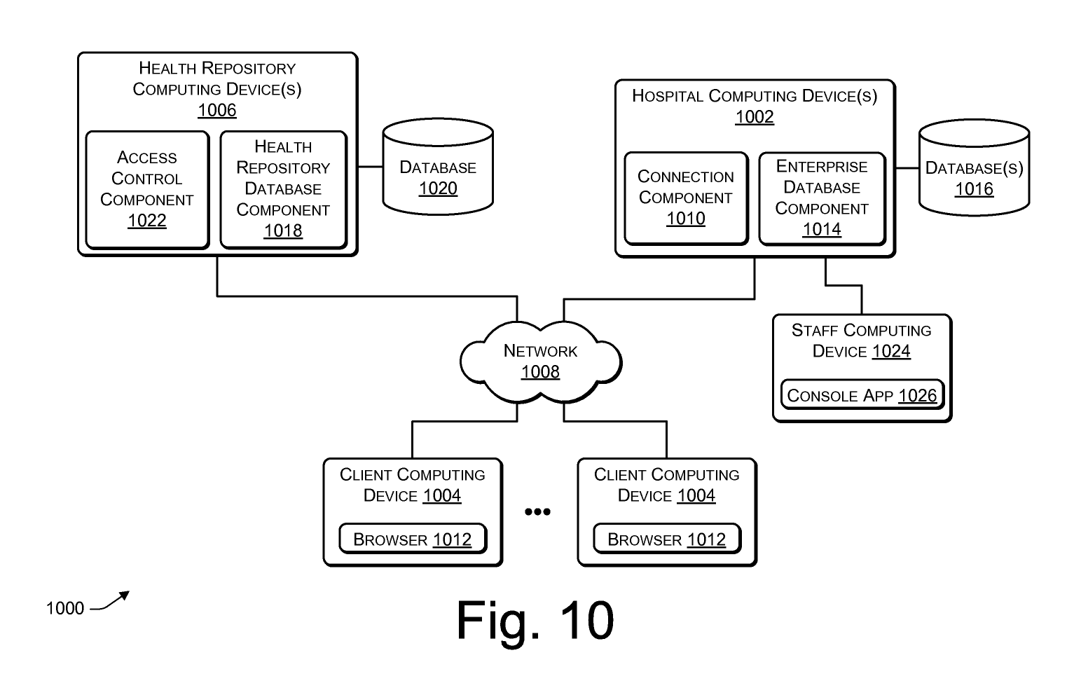

FIG. 10 illustrates a block diagram of an example system architecture 1000 for explanation purposes. In the illustrated example, architecture 1000 includes at least one hospital computing device 1002 able to communicate with a plurality of client computing devices 1004 and at least one health repository computing device 1006 through a network 1008. For example, network 1008 may be the Internet or other suitable communication network enabling communication between hospital computing device 1002, client computing devices 1004 and health repository computing device 1006. Hospital computing device 1002 may include a connection component 1010 able to be accessed by browsers 1012 on client computing devices 1004. For example, in some implementations, connection component 1010 may correspond to connection component 106, 302 described above. Hospital computing device 1002 may also include an enterprise database component 1014 in communication with one or more hospital databases 1016 for obtaining and maintaining patient hospital visit information, as described above. For example, in some implementations, enterprise database component 1014 may correspond to databases 108, 304 described herein. Further, in some implementations, connection component 1010 may be on a separate computing device from enterprise database component 1014 and databases 1016, and/or in a separate physical location.

The client computing devices 1004 may include a variety of user computing devices, patient computing devices, care provider computing devices, and the like, used by users, patients and care providers for accessing the connection component 1010 on the hospital computing device 1002 and/or for accessing health repository computing device 1006. For example, client computing devices 1004 may be any of personal computers, laptops, smartphones, mobile devices, server computers, or other suitable computing devices able to access the hospital computing device 1002 and the health repository computing device 1006, such as over the Internet via the World Wide Web.

In addition, health repository computing device 1006 may include a health information repository component 1018 for providing health repository accounts to users. Health repository database component 1018 may be in communication with a health information database 1020 that contains the health information of multiple users. Health repository computing device 1006 may also include an access control component 1022 for controlling access to the health repository database component 1018 and for protecting the private information contained therein.

Further, in some implementations one or more staff computing devices 1024 may be in communication with the hospital computing device 1002, such as by a local area network (LAN), wide area network (WAN), the Internet, or the like. Staff computing device 1024 may include a console application 1026 able to communicate and interact with the connection component 1010, for enabling the staff to perform the functions described herein, such as assisting in patient matching and linking, allowing or removing connections of care providers, and the like. In some implementations, console application 1026 may be a web browser, web application, or the like. In other implementations, console application may be a proprietary application configured specifically for communication with connection component 1010.

While the foregoing sets forth an example of a system in which the connection component and hospital visit information sharing described above may be implemented, this is merely one example of a possible system, and implementations herein are not limited to any particular system configuration. Accordingly, the connection component and information sharing scenarios disclosed herein may be implemented in any suitable system or environment.

### Example Hospital Computing Device

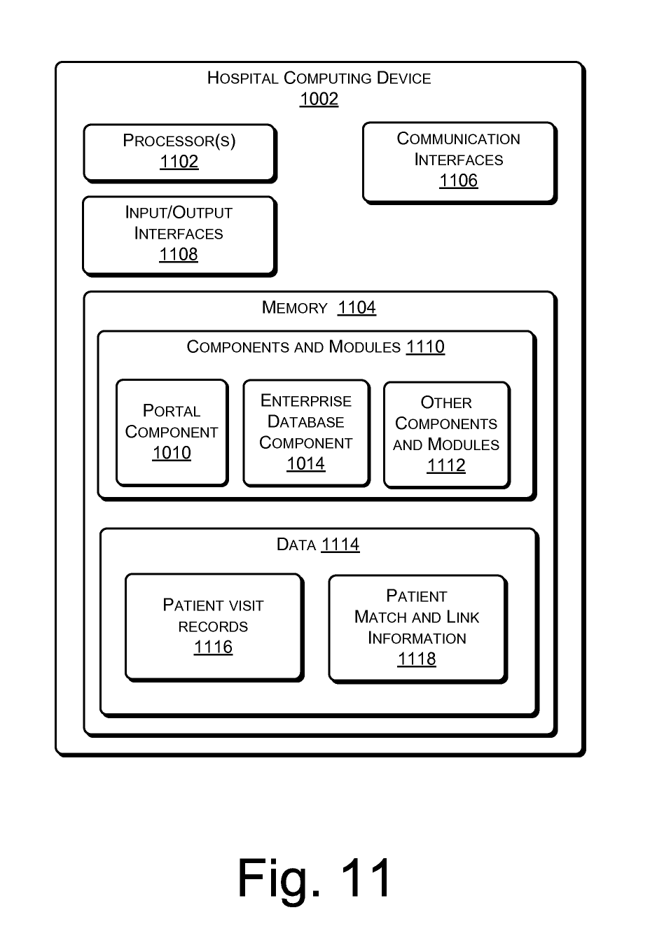

FIG. 11 illustrates an example of the hospital computing device 1002 that can be used to implement the components and modules for patient information access and sharing described herein. In the illustrated example, hospital computing device 1002 includes at least one processor 1102 communicatively coupled to a memory 1104, one or more communication interfaces 1106, and one or more input/output interfaces 1108. The processor 1102 can be a single processing unit or a number of processing units, all of which may include multiple computing units or multiple cores. The processor 1102 may be implemented as one or more microprocessors, microcomputers, microcontrollers, digital signal processors, central processing units, state machines, logic circuitries, and/or any devices that manipulate signals based on operational instructions. Among other capabilities, the processor 1102 can be configured to fetch and execute computer-readable instructions stored in the memory 1104 or other non-transient computer-readable storage media.

The memory 1104 can include any computer-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks (e.g., CD, DVD), storage arrays, storage area networks, network attached storage, or the like, or any combination thereof. The memory 1104 stores computer-readable processor-executable program instructions as computer program code that can be executed by the processor 1102 as a particular machine programmed for carrying out the processes and functions described according to the implementations herein.

The communication interfaces 1106 facilitate communication between the hospital computing device 1002 and the client computing devices 1004, the health repository computing device 1006, and the staff computing device 1024. The communication interfaces 1106 can facilitate communications within a wide variety of networks and protocol types, including wired networks (e.g., LAN, cable, etc.) and wireless networks (e.g., WLAN, cellular, satellite, etc.), the Internet and the like, any of which may correspond to the network 1008. Communication interfaces 1106 can also provide communication with external storage (not shown), such as in a storage array, network attached storage, storage area network, or the like, for maintaining the database(s) 1016. In some implementations, the hospital computing device 1002 can receive communications from a client computing device 1004, the health repository computing device 1006, and/or the staff computing device 1024 via the communication interfaces 1106, and the hospital computing device 1102 can send communications back to the client computing devices 1004, the health repository computing device 1006, and/or the staff computing device 1024 via the communication interfaces 1106.

Memory 1104 includes a plurality of components and program modules 1110 stored therein and executable by processor 1102 for carrying out implementations herein. Components and program modules 1110 include the connection component 1010 and the enterprise database component 1014. Memory 1104 may also include a number of other components and modules 1112, such as an operating system, communication software, drivers, or the like. Additionally, while the connection component 1010 and the enterprise database component 1014 are shown in the examples as being on the same computing device, in other implementations, these components may be operated on one or more separate computing devices.

Memory 1104 also includes data 1114 that may include patient visit records 1116 and patient match and link information 1118. Patient match and link information 1118 may include information such as connection component account information, and matching and linking information for linking the patient visit records to health repository accounts. Further, while an example of an implementation of a hospital computing device architecture has been described, it will be appreciated that other implementations are not limited to the particular architecture described herein.

### Example Health Repository Computing Device

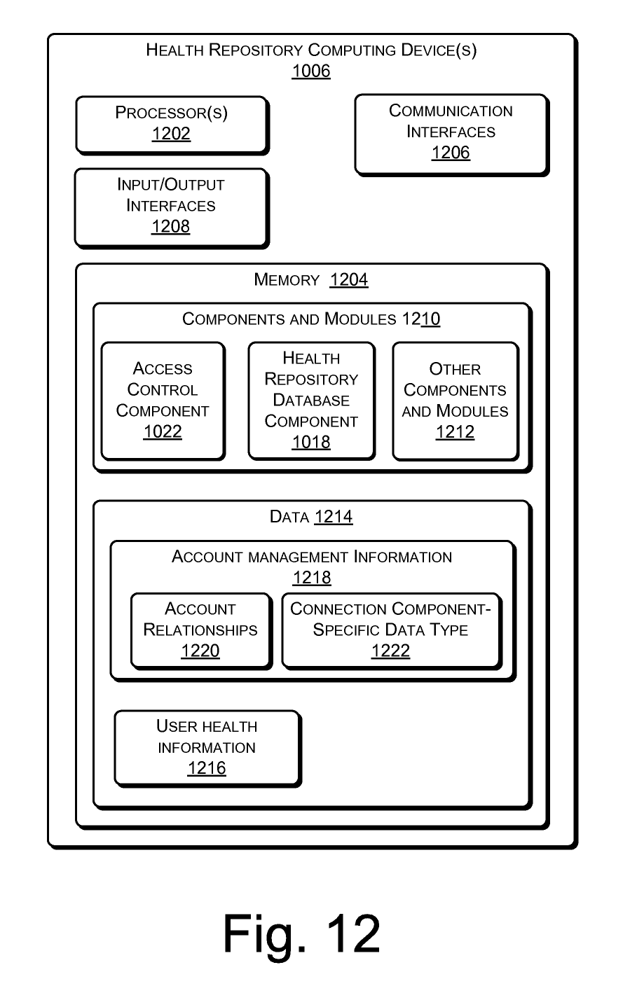

FIG. 12 illustrates an example of health repository computing device 1006 that can be used to implement the health repository accounts described herein. In the illustrated example, health information repository computing device 1006 includes at least one processor 1202 communicatively coupled to a memory 1204, one or more communication interfaces 1206, and one or more input/output interfaces 1208. The processor 1202 can be a single processing unit or a number of processing units, all of which may include multiple computing units or multiple cores. The processor 1202 may be implemented as one or more microprocessors, microcomputers, microcontrollers, digital signal processors, central processing units, state machines, logic circuitries, and/or any devices that manipulate signals based on operational instructions. Among other capabilities, the processor 1202 can be configured to fetch and execute computer-readable instructions stored in the memory 1204 or other non-transient computer-readable storage media.

The memory 1204 can include any computer-readable storage media known in the art including, for example, volatile memory (e.g., RAM) and/or non-volatile memory (e.g., flash, etc.), mass storage devices, such as hard disk drives, solid state drives, removable media, including external drives, removable drives, floppy disks, optical disks (e.g., CD, DVD), storage arrays, storage area networks, network attached storage, or the like, or any combination thereof. The memory 1204 stores computer-readable processor-executable program instructions as computer program code that can be executed by the processor 1202 as a particular machine programmed for carrying out the processes and functions described according to the implementations herein.

The communication interfaces 1206 facilitate communication between the health repository computing device 1006 and the client computing devices 1004 and the hospital computing device 1002. The communication interfaces 1206 can facilitate communications within a wide variety of networks and protocol types, including wired networks (e.g., LAN, cable, etc.) and wireless networks (e.g., WLAN, cellular, satellite, etc.), the Internet and the like, any of which may correspond to the network 1008. Communication interfaces 1206 can also provide communication with external storage (not shown), such as in a storage array, network attached storage, storage area network, or the like, for maintaining the database 1020. In some implementations, the health information repository computing device 1006 can receive communications from a client computing device 1004 and the hospital computing device 1002 via the communication interfaces 1206, and the health information repository computing device 1206 can send communications back to the client computing devices 1004 and the hospital computing device 1002 via the communication interfaces 1206.

Memory 1204 includes a plurality of components and program modules 1210 stored therein and executable by processor 1202 for carrying out implementations herein. Components and program modules 1210 include the health information repository component 1018 and the access control component 1022. Memory 1204 may also include a number of other components and modules 1212, such as an operating system, communication software, drivers, or the like.

Memory 1204 also includes data 1214 that may include user health information 1216 and account management information 1218. Account management information 1218 may include account relationships 1220, such as information such which accounts in the health information repository are able to share records, or the like. Account management information also may include identification of a connection-component-specific data type 1222. As mentioned above, the connection-component-specific data type 1222 is used to enable binding of a connection component patient identifier to multiple health repository accounts and health repository record identifiers for enabling the patient information to be delivered to the correct health record in the health information repository. Further, while an example of an implementation of a hospital computing device architecture has been described, it will be appreciated that other implementations are not limited to the particular architecture described herein.

### Client Computing Device

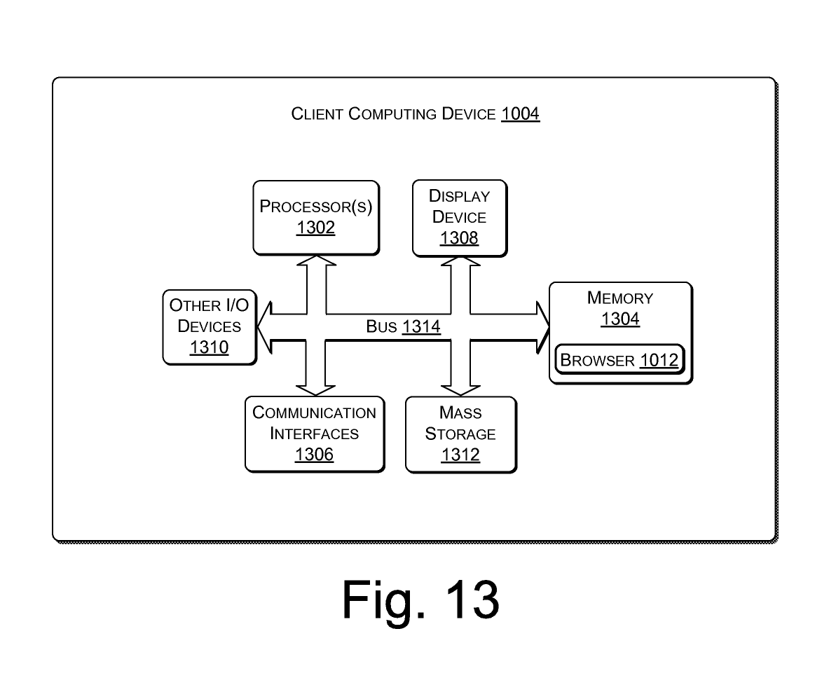

FIG. 13 illustrates an example configuration of a client computing device 1004 that can be used by the patients, care providers, or the like, such as for interacting with the connection component and accessing information on the hospital computing device and/or the health information repository computing device. A configuration similar to client computing device 1004 illustrated in FIG. 13 may also be used for staff computing device 1024. The client computing device 1004 may include at least one processor 1302, a memory 1304, communication interfaces 1306, a display device 1308, other input/output (I/O) devices 1310, and one or more mass storage devices 1312, all able to communicate through a system bus 1314 or other suitable connection.

The processor 1302 may be a single processing unit or a number of processing units, all of which may include single or multiple computing units or multiple cores. The processor 1302 can be implemented as one or more microprocessors, microcomputers, microcontrollers, digital signal processors, central processing units, state machines, logic circuitries, and/or any devices that manipulate signals based on operational instructions. Among other capabilities, the processor 1302 can be configured to fetch and execute computer-readable instructions or processor-accessible instructions stored in the memory 1304, mass storage devices 1312, or other computer-readable storage media.

Browser 1012 described above may be maintained in memory 1304 and executed on processor 1302. Memory 1304 and mass storage devices 1312 are examples of computer-readable storage media for storing instructions which are executed by the processor 1302 to perform the various functions described above. For example, memory 1304 may generally include both volatile memory and non-volatile memory (e.g., RAM, ROM, or the like). Further, mass storage devices 1312 may generally include hard disk drives, solid-state drives, removable media, including external and removable drives, memory cards, Flash memory, floppy disks, optical disks (e.g., CD, DVD), or the like. Both memory 1304 and mass storage devices 1312 may be collectively referred to as memory or computer-readable storage media herein. Memory 1304 is capable of storing computer-readable, processor-executable program instructions as computer program code that can be executed on the processor 1302 as a particular machine configured for carrying out the operations and functions described in the implementations herein.

The client computing device 1304 can also include one or more communication interfaces 1306 for exchanging data with other devices, such as via a network, direct connection, or the like, as discussed above. The communication interfaces 1306 can facilitate communications within a wide variety of networks and protocol types, including wired networks (e.g., LAN, cable, etc.) and wireless networks (e.g., WLAN, cellular, satellite, etc.), the Internet and the like.

A display device 1308, such as a monitor may be included in some implementations for displaying information to users. Other I/O devices 1310 may be devices that receive various inputs from a user and provide various outputs to the user, and can include a keyboard, remote controller, a mouse, audio input/output devices, and so forth. Further, while an example client computing device configuration and architecture has been described, other implementations are not limited to the particular configuration and architecture described herein.

### Example Environments

The example computing devices described herein are merely examples of suitable computing devices for some implementations and are not intended to suggest any limitation as to the scope of use or functionality of the architectures and frameworks that can implement the processes, components and features described herein. Neither should the computing devices described be interpreted as having any dependency or requirement relating to any one or combination of the components illustrated in the implementations herein. Thus, implementations herein are operational with numerous general purpose and special-purpose computing systems, environments or configurations, or other devices having processing capability.

Additionally, the components herein can be employed in many different environments and situations, and are not limited to use in a hospital computing device. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer-readable storage devices. Thus, the processes, components and modules described herein may be implemented by a computer program product. The computer program product may include computer-readable media having a computer-readable program code embodied therein. The computer-readable program code may be adapted to be executed by one or more processors to implement the processes, components and/or modules of the implementations described herein. The terms “computer-readable media,” “processor-accessible media,” or the like, refer to any kind of non-transient machine-readable storage medium for retaining information, and can include the various kinds of storage devices discussed above.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described in connection with the implementations is included in at least one implementation, and the appearances of these phrases in various places in the specification are not necessarily all referring to the same implementation. Additionally, in the description, numerous specific details are set forth in order to provide a thorough disclosure. However, it will be apparent to one of ordinary skill in the art that these specific details may not all be utilized in all implementations. In other circumstances, well-known structures, materials, circuits, processes and interfaces have not been described in detail or are illustrated in block diagram form, so as to not unnecessarily obscure the disclosure.

### CONCLUSION

Implementations described herein provide a patient and/or a patient's care provider with access to patient hospital visit information maintained by a hospital. Some implementations provide a connection component through which the patient or the care provider is able to access the patient's hospital visit records maintained in a hospital database. Consequently, patients are able to independently manage their hospital visit records, preregistrations, and care provider access outside of the hospital infrastructure.

Although the subject matter has been described in language specific to structural features and/or methodological acts, the subject matter defined in the appended claims is not limited to the specific features or acts described above. Rather, the specific features and acts described above are disclosed as example forms of implementing the claims This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A computer-implemented method comprising:
implementing, by a processor, a connection component providing electronic access to hospital visit records maintained in a hospital database;
corresponding a connection component account with a health repository account of a patient maintained by an online health repository; and
presenting an interface by the connection component, the interface providing a list of one or more hospital visit records available for the patient, the list including a listing of reports available for at least one of the hospital visit records in the list.

2. The method according to claim 1, further comprising:
wherein the listing of reports for a particular hospital visit record is generated based on reports currently available for the particular hospital visit record, the listing of reports being assembled before the hospital visit record has been created.

3. The method according to claim 1, further comprising
providing a selected hospital visit record for viewing in the interface,
wherein, when the selected hospital visit record has been previously generated and stored in a cache, the hospital visit record is provided from the cache unless a portion of the selected hospital visit record has been updated subsequent to the storage in the cache, in which case, an updated version of the selected hospital visit record is generated.

4. The method according to claim 1, the interface further providing a listing of care providers permitted to access the hospital visit records of the patient.

5. The method according to claim 1, the interface further providing a selectable option for integrating a hospital visit record into the health repository account of the patient, the integrating comprising adding a portion of information contained in the hospital visit record into information contained in the health repository account based on a correspondence between data types.

6. A computing device comprising:
a processor in communication with computer-readable storage media;
a connection component, maintained in the computer-readable storage media and executed on the processor, to generate a user interface for display to a client computing device, the user interface providing the client computing device with access to hospital visit records of the patient maintained in a hospital database.

7. The computing device according to claim 6, the user interface being configured to display multiple status messages in a single closeable window overlaid on the user interface, the plurality of status messages being of at least two different message types.

8. The computing device according to claim 6, the user interface being configured to concatenate multiple status messages of a same type into a single message displayed in closeable window overlaid on the user interface.

9. The computing device according to claim 8, wherein events triggering the multiple status messages occur at different points in time, the single message being displayed to the user when the user interface of the connection component.

10. The computing device according to claim 6, the user interface being configured to display a list of the hospital visit records for the patient, with at least one of the listed hospital visit records displayed in the user interface listing reports included within the corresponding hospital visit record.

11. The computing device according to claim 10, the list of hospital visit records indicating a status of a particular visit record as being updated when information contained in the visit record has been updated relative to a last time that the patient viewed the hospital visit record, wherein at least one listed report that has been added or updated in the particular visit record is visually indicated as having been updated.

12. The computing device according to claim 10, the list of hospital visit records indicating a status of a particular visit record as being new when the visit record has not yet been viewed by the patient.

13. The computing device according to claim 6, the user interface being configured to provide an indication as to whether a particular patient visit record has been provided to a health repository account of the patient in an online health information repository.

14. The computing device according to claim 6, the user interface being configured to enable selection of one of the listed hospital visit records for displaying in the user interface a continuity of care record corresponding to the selected hospital visit record.

15. The computing device according to claim 6, the user interface being configured to enable selection of one of the listed hospital visit records for displaying the corresponding selected hospital visit record, the corresponding selected hospital visit record being dynamically generated based at least in part on information currently available in the hospital database for the selected hospital visit record.

16. The computing device according to claim 15, the corresponding selected hospital visit record being dynamically generated while the patient is still receiving treatment in the hospital for the selected hospital visit.

17. The computing device according to claim 10, the list of hospital visit records further listing historical visit records accessible for viewing through the connection component, the historical visit records being present on the database prior to installation of the connection component.

18. A method comprising:
implementing, by a processor, a connection component providing electronic access to patient information maintained in a database;
establishing, by the connection component, an identity of a patient for permitting the patient to access the patient's own patient information;
receiving, by the connection component, selection of a care provider by the patient for granting the care provider electronic access to at least a portion of the patient information in the secure database; and
permitting, by the connection component, the care provider to electronically access the patient information.

19. The method according to claim 18, wherein an authorized operator of the connection component uses an operator interface to approve the selection of the care provider prior to permitting the care provider to electronically access the patient information.

20. The method according to claim 19,
wherein receiving the selection of the care provider by the patient further comprises receiving care provider identification information from the patient;
wherein approving the selection of the care provider further comprises matching the care provider identification information received from the patient with care provider information maintained in the secure database.
